(19) United States
(12) Patent Application Publication
(10) Pub. No.: US 2025/0277124 A1
(43) Pub. Date: Sep. 4, 2025

(54) DIOXOLANE AND TERPENE RESIN BASED INKJET INK

(71) Applicant: KAO CORPORATION, Tokyo (JP)

(72) Inventors: Yuta MATSUMOTO, Cincinnati, OH (US); Todd TRITCAK, Cincinnati, OH (US)

(73) Assignee: KAO CORPORATION, Tokyo (JP)

(21) Appl. No.: 18/858,821

(22) PCT Filed: Jun. 30, 2022
(86) PCT No.: PCT/US2022/035840

§ 371 Date: Oct. 22, 2024

(51) Int. Cl. C09D 11/36; C09D 11/033; C09D 11/037; C09D 11/08; C09D 11/328

(52) U.S. Cl. CPC C09D 11/36; C09D 11/033; C09D 11/037; C09D 11/08; C09D 11/328

(57) ABSTRACT

An inkjet ink that includes (A1) a terpene resin, (B) a solvent system containing (B1) dioxolane, and (C) a colorant comprising a metal complex azo dye, the inkjet ink being characterized by extended decap times and superior adhesion to a variety of substrates, A printed article including the inkjet ink in dried form, and a method of forming a printed image with a thermal inkjet printhead are also provided.

### BACKGROUND OF THE INVENTION

### Field of the Invention

The present invention relates to solvent-based inkjet inks, specifically inkjet inks formulated with (A1) a terpene resin, (B) a solvent system comprising (B1) dioxolane, and (C) a colorant comprising a metal complex azo dye.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Thermal inkjet (TIJ) printing is a desirable technology for printing, coding, and marking as it offers high print resolutions at lower costs than competing technologies in the field, such as continuous inkjet (CIJ) methods. In thermal inkjet printing processes, the print cartridges contain a series of tiny chambers, each containing a heater, which produce ink droplets from thermal vaporization of an ink solvent. In the jetting process, a resistor is heated rapidly to produce a vapor bubble (hence the phrase “bubble jet”), which subsequently ejects a droplet from the orifice. This process is extremely efficient and reproducible and modem TIJ printheads for industrial graphics applications are capable of generating uniform droplets of 4 pL or smaller in volume at frequencies of 36 kHz or greater.

However, industrial marking and coding regularly requires the printing of essential information—such as personal information, labels, codes, dating (e.g., expirations dates), and traceability information (e.g., manufacturing lot)—onto substrates having a complex surface, for example, substrates which are radial, curved, serrated, corrugated, fluted, and/or lipped or a variety of different substrates, for example porous and non-porous substrates or substrates formed from materials having different physiochemical properties.

Thermal inkjet printing can be troubled by poor reliability after periods of inactivity. For example, some inkjet inks suffer from short decap times, in which solvent losses due to prolonged exposure to air within an uncapped printhead leads to clogging/plugging of printhead nozzles, and thus unreliable ink jetting and image quality erosion over time.

Solvent-based inkjet inks made using specific combinations of binder resins and volatile organic solvents or solvent mixtures which include dioxolane, and colorants. For example, WO2021145377A1 discloses an inkjet ink comprising dioxolane and a colorant which may be Solvent Black 27, but which does not have sufficient adhesion properties because the lack of resins.

### SUMMARY OF THE INVENTION

In view of the forgoing, there is a need for inkjet inks that have extended decap times, maintain favorable print characteristics over long ink use times, and adhere strongly to multiple substrates.

Accordingly, it is one object of the present invention to provide novel inkjet inks that meet these criteria.

It is another object of the present disclosure to provide novel printed articles which contain a dried form of the inkjet inks.

It is another object of the present disclosure to provide novel methods of forming a printed image on a substrate by applying the inkjet inks onto the substrate and drying.

These and other objects, which will become apparent during the following detailed description, have been achieved by the inventors' discovery that the combination of a terpene resin, dioxolane, and colorants comprising a metal complex azo dye provides inkjet inks characterized by extended decap times, excellent printing longevity, and superior adhesion to a variety of substrates.

Thus, the present invention provides:
1. An inkjet ink, comprising:
(A1) a terpene resin;
(B) a solvent system comprising (B1) dioxolane; and
(C) a colorant comprising a metal complex azo dye.
2. The inkjet ink of (1), wherein the terpene resin (A1) is present in an amount of 0.1 to 10 wt. %, based on a total weight of the inkjet ink.
3. The inkjet ink of (1) or (2), wherein the terpene resin (A1) is a homopolymer made from α-pinene.
4. The inkjet ink of any one of (1) to (3), wherein the dioxolane (B1) is present in an amount of 2 to 98 wt. %, based on a total weight of the inkjet ink.
5. The inkjet ink of any one of (1) to (4), wherein the solvent system (B) further comprises an alcohol solvent (B2).
6. The inkjet ink of (5), wherein the alcohol solvent (B2) is present in an amount of 0.5 to 60 wt. %, based on a total weight of the inkjet ink.
7. The inkjet ink of (5) or (6), wherein a weight ratio of dioxolane (B1) to the alcohol solvent (B2) ((B1):(B2)) is 0.25:1 to 30:1.
8. The inkjet ink of any one of (1) to (7), wherein a weight ratio of dioxolane (B1) to the terpene resin (A1) ((B1):(A1)) is 20:1 to 250:1.
9. The inkjet ink of any one of (1) to (8), wherein the solvent system (B) is substantially free of methyl ethyl ketone.
10. The inkjet ink of (9), wherein the solvent system (B) is devoid of methyl ethyl ketone.
11. The inkjet ink of any one of (1) to (10), wherein the metal complex azo dye is a metal complex comprising:
a metal center; and
(E)-1-((2-methoxy-5-nitrophenyl)diazenyl)naphthalen-2-ol or a deprotonated form, demethylated form, deprotonated and demethylated form, tautomer, or stereoisomer thereof.
12. The inkjet ink of (11), wherein the metal center is a chromium ion.
13. The inkjet ink of any one of (1) to (12), wherein the colorant (C) is present in an amount of 0.5 to 20 wt. %, based on a total weight of the inkjet ink.
14. The inkjet ink of any one of (1) to (13), further comprising (A2) a terpene phenol resin.
15. The inkjet ink of (14), wherein the terpene phenol resin (A2) is present in an amount of 0.01 to 10 wt. %, based on a total weight of the inkjet ink.
16. The inkjet ink of any one of (1) to (15), further comprising (D) a surfactant.
17. The inkjet ink of (16), wherein the surfactant (D) is present in an amount of 0.01 to 5 wt. %, based on a total weight of the inkjet ink.
18. The inkjet ink of any one of (16) or (17), wherein the surfactant (D) is a silicone acrylate copolymer.
19. A printed article, comprising:
a substrate and a dried form of the inkjet ink of any one of (1) to (18) disposed on the substrate.
20. A method of forming a printed image on a substrate, comprising:
applying the inkjet ink of any one of (1) to (18) onto the substrate with a thermal inkjet printhead; and drying the inkjet ink.

### BRIEF DESCRIPTION OF THE DRAWINGS

The foregoing paragraphs have been provided by way of general introduction, and are not intended to limit the scope of the following claims. The described embodiments, together with further advantages, will be best understood by reference to the following detailed description when considered in conjunction with the accompanying drawings, wherein:

FIG. 1 illustrates the evaluation of printed inks for a “Good” rating (clearly readable, clear and well-defined image), an “Acceptable” rating (readable, mostly clear with some haziness or slight loss of edge definition), and a “Not Good” rating (not readable, lacks clarity and is poorly defined) for an alphanumeric sequence;

FIG. 2 illustrates the print longevity evaluation for a “Good” rating (consistent clear and well-defined image, alignment maintained) and a “Not Good” rating (lacks clarity, image poorly defined, alignment not maintained) for both an alphanumeric sequence and a solid image.

FIG. 3 illustrates the adhesion evaluation via the peeled tape test for a “Good” rating (little to no ink on tape; no change to print), an “Acceptable” rating (significant ink on tape; noticeable change to print, e.g. reticulation or fading), and a “Not Good” rating (large amount of ink on tape; print significantly degraded in quality, e.g. reticulation or fading) for a printed image.

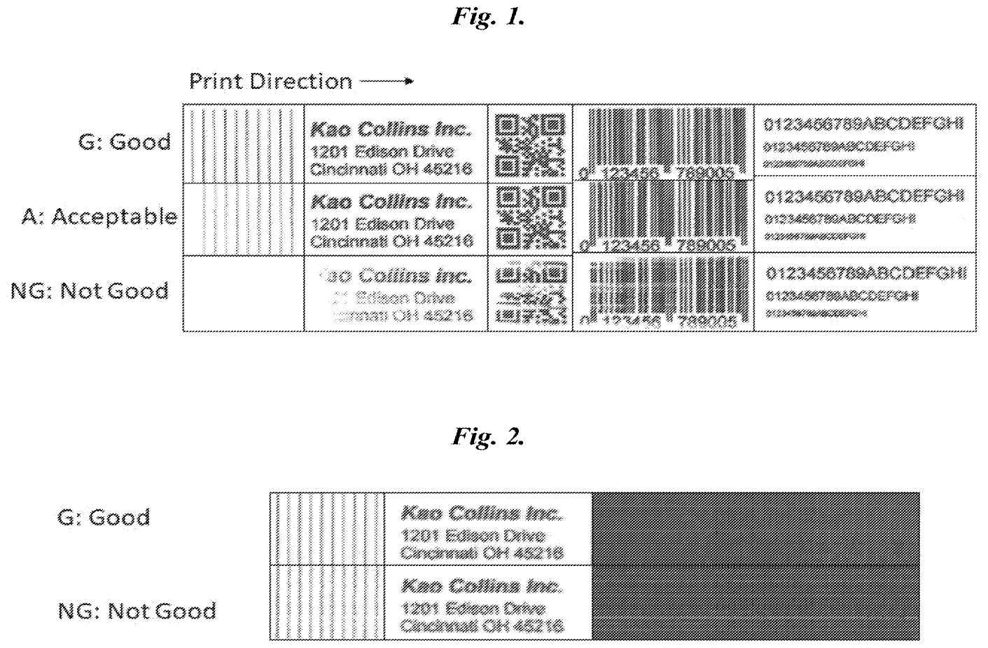

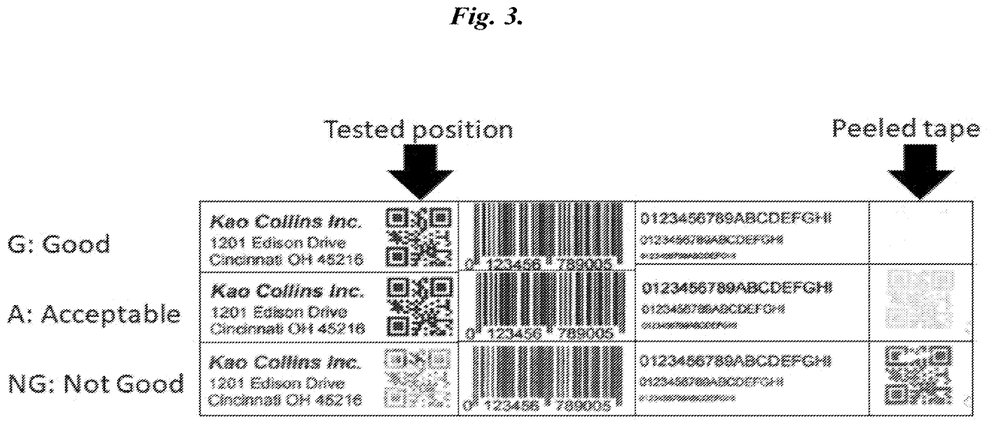

### DETAILED DESCRIPTION OF THE INVENTION

In the following description, it is understood that other embodiments may be utilized and structural and operational changes may be made without departure from the scope of the present embodiments disclosed herein.

The phrase “substantially free”, unless otherwise specified, describes an amount of a particular component in the inkjet ink being less than 1 wt. %, preferably less than 0.5 wt. 00 more preferably less than 0.1 wt. %, even more preferably less than 0.05 wt. %, yet even more preferably 0 wt. %, relative to a total weight of the inkjet ink.

As used herein, the terms “optional” or “optionally” means that the subsequently described event(s) can or cannot occur or the subsequently described component(s) may or may not be present (e.g., 0 wt. %).

The term “alkyl”, as used herein, unless otherwise specified, refers to a straight, branched, or cyclic, aliphatic fragment having at least 1, preferably at least 2, preferably at least 3, preferably at least 4 carbon atoms, and up to 22, preferably up to 20, preferably up to 18, preferably up to 12, preferably up to 8 carbon atoms. Examples of alkyl groups include, but are not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, lauryl, myristyl, cetyl, stearyl, and the like, including guerbet-type alkyl groups (e.g., 2-methylpentyl, 2-ethylhexyl, 2-proylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl). Cycloalkyl is a type of cyclized alkyl group. Exemplary cycloalkyl groups include, but are not limited to, cyclopropyl, cyclobutyl, cyclopentyl, cyclohexyl, norbornyl, and adamantyl.

As used herein, the term “fatty” describes a compound with a long-chain (linear) hydrophobic portion made up of hydrogen and anywhere from 8 to 22 carbon atoms, which may be fully saturated or partially unsaturated.

As used herein, the term “aryl” refers to an aromatic group containing only carbon in the aromatic ring(s), such as phenyl, biphenyl, naphthyl, anthracenyl, and the like.

The term “arylalkyl”, as used herein, refers to a straight, branched, or cyclic alkyl moiety (as defined above) that is substituted by an aryl group (as defined above) which may itself be optionally substituted by an alkyl group, examples of which include, but are not limited to, benzyl, phenethyl, 3-phenylpropyl, 2-phenylpropyl, 1-phenylpropyl, 4-phenylbutyl, 3-phenylbutyl, 2-phenylbutyl, 2-methylbenzyl, 3-methylbenzyl, 4-methylbenzyl, 2,4-dimethylbenzyl, 2-(4-ethylphenyl)ethyl, 3-(3-propylphenyl)propyl, and the like.

The term “(meth)acrylate” is used herein to refer to both acrylate and methacrylate groups. In other words, this term should be read as though “meth” is optional. Further, the term “(meth)acrylate” is used generally to refer to both acrylic acid-based compounds and acrylic ester-based compounds.

Throughout the specification, the term “boiling point” (b.p.) refers to the boiling point of a liquid measured at sea-level atmospheric pressure (i.e., 760 mmHg or 1 atmosphere), also called the normal boiling point, unless specified otherwise.

The term “decap behavior” herein, means the ability of the inkjet ink to readily eject from the printhead, upon prolonged exposure to air. The inkjet ink “decap time” is measured as the amount of time that an inkjet printhead may be left uncapped before the printer nozzles no longer fire properly, potentially because of clogging or plugging when printing resumes. Generally, nozzle(s) may become clogged (i.e., impeded, slowed) or plugged (i.e., obstructed, substantially or completely closed) by a viscous plug that forms in the nozzle(s) as a result of solvent loss, crusting of the ink, and/or kogation of various ink components in and/or around any of the nozzles. If a nozzle has become clogged, ink droplets ejected through the nozzle's orifice may be misdirected, which may adversely affect print quality. When an orifice is plugged, it becomes substantially or completely blocked. As a result of the nozzle being plugged, the ink droplets may not pass through the affected nozzle. Thus, the criteria for measuring failure to fire by a nozzle is a misdirection of ink through the nozzle's orifice to a lesser or greater degree, or a complete blockage, which can be measured by visually inspecting a printed image.

The term “reticulation” refers to a printing defect characterized by a withdrawal of ink film from portions of the substrate due to incompatibilities between the inkjet ink and the surface of the substrate. Reticulation often causes images to be produced with an “orange peel” or “pinhole” effect.

### Inkjet Inks

The present disclosure is directed to inkjet inks that possess suitable physical and chemical stability at both ambient temperatures and printhead operating temperatures, are jetted reliably, exhibit good adhesion to porous and non-porous substrates, have prolonged decap times while still drying quickly after being applied onto a substrate.

Inkjet inks of the present disclosure generally include the following components: (A1) a terpene resin, (B) a solvent system comprising (B1) dioxolane, and (C) a colorant comprising a metal complex azo dye.

The inkjet inks of the present disclosure may also optionally include one or more of (A2) a terpene phenol resin, (B2) an alcohol solvent as part of the solvent system (B), (D) a surfactant, and (E) an additive.

### (A) Resin(s)

Inkjet inks of the present disclosure are formulated with a terpene resin (A1). Typically, the terpene resin (A1) is employed in an amount of preferably at least 0.1 wt. %, preferably at least 0.2 wt. 00 preferably at least 0.3 wt. 00 preferably at least 0.4 wt. %, preferably at least 0.5 wt. 00 preferably at least 0.6 wt. 00 more preferably at least 0.7 wt. 00 yet even more preferably at least 0.75 wt. %, yet even more preferably at least 0.8 wt. %, and preferably up to 10 wt. %, preferably up to 9 wt. %, preferably up to 8 wt. %, preferably up to 7 wt. %, preferably up to 6 wt. %, preferably up to 5 wt. %, more preferably up to 4 wt. %, even more preferably up to 3 wt. %, yet even more preferably up to 2.5 wt. %, based on a total weight of the inkjet ink.

The terpene resin (A1) of the present disclosure refers to oligomers or polymers having preferably at least 95 wt. %, preferably at least 96 wt. %, more preferably at least 97 wt. %, more preferably at least 98 wt. %, more preferably at least 99 wt. %, even more preferably at least 99.5 wt. %, yet even more preferably 100 wt. % of constitutional units derived from a polymerizable terpene(s), based on the total constitutional units (100 wt. %) of the terpene resin (A1).

The constitutional units other than the terpene constituting the terpene resin (A1) may be any units co-polymerizable with the terpene, but is not a phenol. That is, in the present invention, the terpene resin (A1) is not a terpene phenol resin.

Terpenes have a basic skeleton (C₅H₈)ₚ where p is a positive integer that delineates the number of isoprene units that are successively bound head to tail. For example, hemiterpenes (p=1) have a C₅H₈ skeleton, monoterpenes (p=2) have a C₁₀H₁₆ skeleton, sesquiterpenes (p=3) have a C₁₅H₂₄ skeleton, and so forth.

In some embodiments, the terpene resin (A1) is based on monoterpene monomer units. The monoterpene may be a linear monoterpene (e.g., myrcene, ocimene, etc.), a monocyclic monoterpenes (e.g., limonene, γ-terpinene, α-phellandrene, β-phellandrene, terpinolene, etc.), or a bicyclic monoterpene (e.g., 3-carene, α-pinene, β-pinene, α-fenchene, camphene, etc.), including the various stereoisomers thereof, as well as mixtures thereof. In some embodiments, the monoterpene is a monocyclic monoterpene, with particular preference to limonene. In preferred embodiments, the monoterpene is a bicyclic monoterpene, with particular preference to 3-carene, α-pinene, β-pinene, and camphene, more preferably α-pinene and/or β-pinene, even more preferably α-pinene.

Preferred inkjet inks are those formulated with a terpene resins (A1) made from polymerization or oligomerization of α-pinene. As known by those of ordinary skill in the art, such terpene resins may be readily obtained for example through catalytic polymerization/oligomerization (in solution) of α-pinene monomers, which are in turn typically derived from fractional distillation of gum and sulfate turpentines obtained from pines such as Pistacia terebinthus, Pinus pinaster, Pinus halepensis, Pinus massoniana, Pinus merkusii, Pinus palustris, Pinus taeda, and Pinus ponderosa.

In preferred embodiments, the terpene resin (A1) is a homopolymer made from α-pinene, with an α-pinene content (constitutional units derived from α-pinene) of preferably at least 95 wt. %, preferably at least 96 wt. %, preferably at least 97 wt. 00 preferably at least 98 wt. %, preferably at least 99 wt. %, more preferably at least 99.5 wt. 00 even more preferably at least 99.9 wt. %, yet even more preferably 100 wt. %, based on the total constitutional units (100 wt. %) of the terpene resin (A1). While the terpene resins (A1) of the present disclosure may include small amounts of other constitutional units other than constitutional units derived from α-terpene monomers, the amount of other (e.g., non-terpene based) constitutional units is preferably less than 5 wt. %, preferably less than 3 wt. %, preferably less than 1 wt. %, more preferably less than 0.5 wt. %, even more preferably less than 0.1 wt. %, yet even more preferably 0 wt. %, based on the total constitutional units (100 wt. %) of the terpene resins (A1).

In some embodiments, the terpene resin (A1) is a homopolymer made from β-pinene, with a β-pinene content (constitutional units derived from β-pinene) of preferably at least 95 wt. %, preferably at least 96 wt. %, preferably at least 97 wt. 00 preferably at least 98 wt. 00 preferably at least 99 wt. %, more preferably at least 99.5 wt. 00 even more preferably at least 99.9 wt. %, yet even more preferably 100 wt. %, based on the total constitutional units (100 wt. %) of the terpene resin (A1). While the terpene resins (A1) of the present disclosure may include small amounts of other constitutional units other than constitutional units derived from β-terpene monomers, the amount of other (e.g., non-terpene based) constitutional units is preferably less than 5 wt. %, preferably less than 3 wt. %, preferably less than 1 wt. %, more preferably less than 0.5 wt. %, even more preferably less than 0.1 wt. %, yet even more preferably 0 wt. %, based on the total constitutional units (100 wt. %) of the terpene resins (A1).

Both polymeric and oligomeric forms of the terpene resin (A1) may be used herein, including combinations thereof. Typically, terpene resins (A1) are used herein that have a number average molecular weight (Mn) of preferably at least 330 g/mol, preferably at least 340 g/mol, preferably at least 400 g/mol, preferably at least 450 g/mol, preferably at least 500 g/mol, preferably at least 550 g/mol, preferably at least 600 g/mol, more preferably at least 650 g/mol, even more preferably at least 700 g/mol, yet even more preferably at least 750 g/mol, and preferably up to 1,500 g/mol, preferably up to 1,300 g/mol, preferably up to 1,100 g/mol, preferably up to 1,000 g/mol, more preferably up to 900 g/mol, even more preferably up to 800 g/mol, yet even more preferably up to 790 g/mol.

The terpene resins (A1) may be in the form of a solid or a liquid at room temperature. When in the form of a solid, the terpene resin (A1) utilized herein may be categorized based upon its softening point (SP), for example according to a ring-and-ball softening point method. The ring-and-ball softening point is defined as the temperature at which a disk of the sample held within a horizontal ring is forced downward a distance of 1 in. (25.4 mm) under the weight of a steel ball as the sample is heated at a prescribed rate in a glycerol bath. For example, the ring-and-ball softening point may be determined according to JIS B7410-which is incorporated herein by reference in its entirety-Measuring apparatus: Automatic Ring-and-Ball Softening Point; Tester: ASP-MGK2, manufactured by MEITECH Company Ltd.; Heating rate: 5° C./min; Temperature at which heating is started: 40° C.; Measurement solvent: glycerol. Terpene resins (A1) having a variety of softening points may be used herein, for example, preferably those with a softening point of at least 20° C., preferably at least 22° C., and preferably up to 50° C., preferably up to 45° C., preferably up to 40° C., more preferably up to 35° C., even more preferably up to 30° C., yet even more preferably up to 28° C. In preferred embodiments, the terpene resin (A1) has a softening point of at least 20° C., preferably at least 22° C., more preferably at least 24° C., and up to 50° C., preferably up to 45° C., preferably up to 40° C., more preferably up to 35° C., even more preferably up to 30° C., yet even more preferably up to 28° C.

Bromine number is the amount of bromine (Br₂) in grams absorbed by 100 grams of a sample, and is an indicator of the degree of unsaturation of the sample. In some embodiments, the terpene resin (A1) employed in the inkjet inks has a bromine number of preferably at least 12, preferably at least 15, preferably at least 19, preferably at least 22, more preferably at least 25, even more preferably at least 26, yet even more preferably at least 27, and preferably up to 35, preferably up to 34, preferably up to 33, more preferably up to 32, even more preferably up to 31, yet even more preferably up to 30, although terpene resins (A1) having a bromine number above or below (e.g., hydrogenated terpene resins (A1)) these values may also find use in the disclosed inkjet inks.

The inkjet inks of the present disclosure may be formulated with a single type of terpene resin (A1), or with a combination of two or more types of terpene resins (A1). Examples of terpene resins (A1) that may be employed in the inkjet inks herein, either alone or in combination, include, but are not limited to, PICCOLYTE A115 (ring-and-ball SP=112-118° C., bromine number=31.5), PICCOLYTE A125 (ring-and-ball SP=122-128° C., bromine number=31.5), PICCOLYTE A135 (ring-and-ball SP=132-138° C., bromine number=27), PICCOLYTE A135 PLUS (ring-and-ball SP=132-138° C.), PICCOLYTE AO PLUS (oligomer, liquid), PICCOLYTE A25 (ring-and-ball SP=22-28° C.), and PINOVA RESIN 2495 (ring-and-ball SP=132-138° C., bromine number=27), each being made from high purity α-pinene, available from Pinova, as well as PICCOLYTE S25 (made from high purity β-pinene, ring-and-ball SP=22-28° C., bromine number 19), available from Pinova. A particularly preferred terpene resin (A1) for use in the disclosed inkjet inks is PICCOLYTE A25.

The terpene resin (A1) has been found to provide superior decap times, running stability (ink longevity), and adhesion when used in combination with dioxolane (B1) and a colorant comprising a metal complex azo dye. Without being bound by theory, it is believed that the terpene resin (A1) improves the decap behavior and/or running stability of the inkjet inks by forming a thin ‘skin’ or ‘film’ covering within the printhead nozzles, thereby creating a temporary seal that prevents or reduces solvent losses during periods of inactivity, but where the ‘skin’ or ‘film’ can be easily broken once the printing operation resumes.

The formation of such a ‘skin’ or ‘film’ may be advantageous for maintaining high performance across a wide variety of decap times. Such advantage may be due to rapid formation of this ‘skin’ or ‘film.’ Surprisingly, for the evaluation of decap times, the shorter the time, the more difficult it is to achieve a good result, for example for 10 minutes vs. 60 minutes. This may be related to long decap times allowing the thin ‘skin’ or ‘film’ by the terpene resin to be fully formed, even for a wide variety of ink formulations. This ‘skin’ or ‘film’ of the nozzle is easily destroyed by the impact of the resumption of discharge. In contrast, when the decap time is short, other formulations of inks are unable to form this thin ‘skin’ or ‘film’ and are only in a state of highly viscous liquid. Thus, the impact at the time of resumption of discharge is mitigated and the formation of droplets is incomplete, giving poor ink performance. On the other hand, the ink of the present disclosure can form a complete thin ‘skin’ or ‘film’ even in a short time like 30 seconds, giving the ink superior decap performance across a wide variety of decap times. This quick ‘skin’ or ‘film’ formation behavior would be derived from the suitable interaction between the terpene resin (A1), solvent system especially dioxolane (B1) and the colorant (C), especially a metal complex azo dye.

In addition to the terpene resin (A1), the inkjet inks disclosed herein may optionally be formulated with a terpene phenol resin (A2). When employed, the terpene phenol resin (A2) may be used in amounts of preferably at least 0.01 wt. %, preferably at least 0.025 wt. %, preferably at least 0.05 wt. 00 preferably at least 0.075 wt. %, preferably at least 0.1 wt. %, preferably at least 0.15 wt. %, at least 0.2 wt. %, preferably at least 0.25 wt. %, preferably at least 0.3 wt. %, preferably at least 0.35 wt. %, preferably at least 0.4 wt. %, preferably at least 0.45 wt. %, preferably at least 0.475 wt. %, more preferably at least 0.5 wt. %, and preferably up to 10 wt. %, preferably up to 9 wt. %, preferably up to 8 wt. %, preferably up to 7 wt. %, preferably up to 6 wt. %, preferably up to 5 wt. %, more preferably up to 4 wt. %, even more preferably up to 3 wt. %, yet even more preferably up to 2 wt. %, yet even more preferably up to 1 wt %, yet even more preferably up to 0.8 wt. %, based on a total weight of the inkjet ink. Preferably, the amount (in terms of weight %) of terpene phenol resin (A2) is less than or equal to the amount of terpene resin (A1) in the inkjet ink when terpene phenol resin (A2) is employed. In some embodiments, the inkjet inks are substantially free of terpene phenol resin (A2).

Terpene phenol resins (A2) are the copolymeric reaction products from alkylation of one or more phenolic compounds with one or more terpenes. As known by those of ordinary skill in the art, such resins may be readily obtained through copolymerization of a phenolic compound and a terpene monomer under the catalytic action of strong acids, metal salts having a condensing effect, bleaching earths, Friedel-Craft catalysts or strong Lewis acids, (e.g., boron trifluoride), and the like.

While the terpene phenol resins (A2) of the present disclosure may include small amounts of other constitutional units other than the constitutional units derived from phenolic compounds and constitutional units derived from terpene, the amount of other (e.g., non-phenol and non-terpene based) constitutional units is preferably less than 5 wt. %, preferably less than 4 wt. %, preferably less than 3 wt. %, preferably less than 2 wt. %, more preferably less than 1 wt. %, even more preferably less than 0.5 wt. %, yet even more preferably 0 wt. %, based on the total constitutional units (100 wt. %) of the terpene phenol resin (A2).

The terpene phenol resin (A2) may be formed using any terpene having at least one olefinic double bond that is capable of being alkylated by a phenolic compound. In some embodiments, the terpene phenol resin (A2) is formed using monoterpene monomer units. The monoterpene may be a linear monoterpene (e.g., myrcene, ocimene, etc.), a monocyclic monoterpenes (e.g., limonene, γ-terpinene, α-phellandrene, β-phellandrene, terpinolene, etc.), or a bicyclic monoterpene (e.g., 3-carene, α-pinene, β-pinene, α-fenchene, camphene, etc.), including the various stereoisomers thereof, as well as mixtures thereof. In some embodiments, the monoterpene is a monocyclic monoterpene, with particular preference to limonene. In preferred embodiments, the monoterpene is a bicyclic monoterpene, with particular preference to 3-carene, α-pinene, β-pinene, and camphene, more preferably α-pinene and/or β-pinene.

A phenolic compound has at least one hydroxyl group directly bonded to a phenyl ring. All mono- or polyvalent phenolic compounds are useful in the preparation of the terpene phenol resin (A2) described herein provided that the phenolic compound has at least two replaceable hydrogen atoms in ortho- and/or para-positions with respect to at least one hydroxyl group. That is, the phenolic compound should be capable of being polyalkylated (e.g., bis-alkylated) with the terpene(s), and thus should have at least two available ortho-/para-positions with respect to at least one hydroxyl group for alkylation.

In preferred embodiments, the phenolic compound is phenol, which is considered the parent unsubstituted phenolic compound (i.e., contains one hydroxyl group bonded directly to the phenyl ring with no other substitution). Alternatively, the phenolic compound may be substituted at up to three positions in addition to the phenolic hydroxyl group, wherein one, two or three of the aromatic hydrogens of phenol are replaced with an equal number of substituents, each independently selected from a hydroxyl group; preferably a C₁-C₂₂ alkyl group, preferably a C₂-Cis alkyl group, more preferably a C₃-C₁₂ alkyl group, even more preferably a C₄-C₉ alkyl group, for example, methyl, ethyl, n-propyl, isopropyl, n-butyl, isobutyl, tert-butyl; a C₁-C₂₂ alkoxy group, preferably a C₂-C₁₂ alkoxy group, more preferably a C₃-C₆ alkoxy group, for example, methoxy, ethoxy, and isopropoxy; an aryl group; an arylalkyl group, for example a benzyl group; and a halo group such as chlorine, bromine, fluorine and iodine.

Specific examples of substituted phenolic compounds include, but are not limited to, o-cresol, m-cresol, p-cresol, 2,5-xylenol, 2,3-xylenol, 3,4-xylenol, 3,5-xylenol, 2,3,5-trimethylphenol, isopropylphenol (e.g., 4-isopropylphenol), tert-butylphenol (e.g., 4-tert-butylphenol), amylphenol (e.g., 4-tert-amylphenol), heptylphenol (e.g., 4-heptylphenol), octylphenol (e.g., o-octylphenol, p-octylphenol, etc.), nonylphenol (e.g., 4-(2,4-dimethylheptan-3-yl)phenol), decylphenol, dodecylphenol, bisphenols such as diphenylolpropane (bisphenol-A), phenylphenol (e.g., 3-phenylphenol), cumylphenol, mequinol, benzyloxyphenol, guaiacol, ethoxyphenol (e.g., 4-ethoxyphenol), as well as polyhydric phenolic compounds such as resorcinol, pyrogallol, catechol, and p-hydroquinone, including mixtures of two or more of any of the above. Also included are fused ring phenols such as naphthols (e.g., 1-naphthol, 2-naphthol, etc.) and similar compounds. Preferred terpene phenol resins (A2) are those formed from copolymerization of phenol and one or more of α-pinene, 0-pinene, and limonene.

The molecular weight of the terpene phenol resin (A2) may vary depending on the monomers utilized, the reaction conditions, among many other factors, but typically terpene phenol resins (A2) are used that have a weight average molecular weight (Mw) of preferably at least 400 g/mol, preferably at least 500 g/mol, more preferably at least 600 g/mol, even more preferably at least 700 g/mol, and up to 3,000 g/mol, preferably up to 2,500 g/mol, more preferably up to 2,000 g/mol, even more preferably up to 1,500 g/mol, yet even more preferably up to 1,000 g/mol.

The terpene phenol resin (A2) may be categorized based upon its softening point (SP), for example according to the ring-and-ball softening point method as described heretofore (e.g., according to JIS B7410-incorporated herein by reference in its entirety). In some embodiments, the terpene phenol resin (A2) has a softening point of preferably at least 60° C., preferably at least 80° C., preferably at least 90° C., preferably at least 100° C. preferably at least 105° C., more preferably at least 110° C., even more preferably at least 115° C., yet even more preferably at least 120° C., and preferably up to 160° C., preferably up to 155° C., preferably up to 150° C., preferably up to 145° C., preferably up to 140° C., more preferably up to 135° C., even more preferably up to 130° C., yet even more preferably up to 125° C.

The hydroxyl value (OHV) is defined as the number of milligrams of potassium hydroxide required to neutralize the acetic acid taken up on acetylation of one gram of a chemical substance that contains free hydroxyl groups. Therefore, the hydroxyl value, or the measure of the relative hydroxyl content of the terpene phenol resin (A2), is directly correlated to the content of the phenolic compound(s) within the terpene phenol resin (A2), with higher hydroxyl values indicating higher phenolic compound incorporation into the copolymer (and lower terpene incorporation). Hydroxyl values can be determined according to Japanese Industrial Standards JIS K 0070: 1992 “Test methods for acid value, saponification value, ester value, iodine value, hydroxyl value, and unsaponifiable matter of chemical products.”

The hydroxyl value of the terpene phenol resin (A2) employed in the disclosed inkjet inks may vary, for example, from 10 mgKOH/g to 150 mgKOH/g. However, in terms of decap behavior and compatibility with the solvent system (B), preferred terpene phenol resins (A2) are those having a hydroxyl value of preferably at least 10 mgKOH/g, preferably at least 15 mgKOH/g, preferably at least 20 mgKOH/g, preferably at least 22 mgKOH/g, preferably at least 24 mgKOH/g, preferably at least 25 mgKOH/g, preferably at least 28 mgKOH/g, preferably at least 30 mgKOH/g, preferably at least 32 mgKOH/g, preferably at least 34 mgKOH/g, more preferably at least 36 mgKOH/g, even more preferably at least 38 mgKOH/g, yet even more preferably at least 40 mgKOH/g, and preferably up to 80 mgKOH/g, preferably up to 75 mgKOH/g, preferably up to 70 mgKOH/g, preferably up to 65 mgKOH/g, preferably up to 60 mgKOH/g, more preferably up to 55 mgKOH/g, even more preferably up to 50 mgKOH/g, yet even more preferably up to 45 mgKOH/g, with hydroxyl values (OHV) of 20 to 60 mgKOH/g being the most preferred.

Examples of suitable terpene phenol resins (A2) that may be optionally employed in the inkjet inks herein, either alone or in combination, include, but are not limited to, YS POLYSTER products such as YS POLYSTER U130 (OHV=25 mgKOH/g; SP=130° C.), YS POLYSTER U115 (OHV=30 mgKOH/g; SP=115° C.), YS POLYSTER T160 (OHV=60 mgKOH/g; SP=160° C.), and YS POLYSTER T145 (OHV=65 mgKOH/g; SP=145° C.), available from Yasuhara Chemical Co. Ltd., and DERTOPHENE products such as DERTOPHENE T (OHV=20-50 mgKOH/g; SP=95° C.; Mw=700 g/mol), DERTOPHENE T105 (OHV=40 mgKOH/g; SP=105° C.; Mw=700 g/mol), DERTOPHENE T115 (OHV=50 mgKOH/g; SP=120° C.; Mw=700 g/mol), and DERTOPHENE T160 (OHV=60 mgKOH/g; SP=160° C.; Mw=about 1,000 g/mol), available from DRT/Pinova. A particularly preferred terpene phenol resin (A2) is DERTOPHENE T160.

In addition to the terpene resin (A1), and any optional terpene phenol resin (A2), the inkjet inks may optionally contain other binder resins/tackifiers/adhesive substances in an amount of preferably at least 0.1 wt. %, preferably at least 0.5 wt. %, preferably at least 1 wt. %, more preferably at least 1.5 wt. %, even more preferably at least 2 wt. %, yet even more preferably at least 2.5 wt. %, and preferably up to 10 wt. %, preferably up to 9 wt. %, preferably up to 8 wt. %, preferably up to 7 wt. %, preferably up to 6 wt. %, more preferably up to 5 wt. %, even more preferably up to 4 wt. %, yet even more preferably up to 3 wt. %, based on a total weight of the inkjet ink. Such additional resins, binders, tackifiers, or adhesive substances may include, but are not limited to,
rosin resins, such as rosin resins derived from gum rosin, wood rosin, and tall oil rosin (the main components of which are resin acids such as abietic acid, palustric acid, neoabietic acid, pimaric acid, isopimaric acid and/or dehydroabietic acid), including rosin resins formed by modifying the aforementioned rosins through esterification, hydrogenation (including partial hydrogenation), dimerization, and/or other modifications/functionalization (e.g., through Diels-Alder reaction with an unsaturated di-acid like maleic or fumaric acid/anhydride, carboxylic acid reduction to the respective aldehydes/alcohols, double bond isomerization, dehydrogenation, oxidation, disproportionation, and the like). Exemplary rosin resins include, but are not limited to (1) a rosin ester resin, such as e.g., an ester of a rosin composed mainly of an abietic type or pimaric type resin acid that has been reacted with an alcohol(s) such as glycerin, pentaerythritol, ethylene glycol, diethylene glycol, triethylene glycol, methanol, etc., and optionally hydrogenated or partially hydrogenated, with specific mention being made to HARIESTER products available from Harima Chemicals, Inc., STAYBELITE ESTER 10-E and PERMALYN 6110, each available from Eastman, SUPER ESTER A-125, SUPER ESTER A-75, PENSEL D-125, PINECRYSTAL KE-359 available from Arakawa Chemical Industries, Ltd., and FORAL 85, FORAL 105, HERCOLYN products, PEXALYN products, and PENTALYN products available from Pinova; (2) a hydrogenated acidic rosin such as FORAL AX and FORAL DX, each available from Pinova; (3) a partially hydrogenated acidic rosin such as STAYBELITE RESIN-E, available from Eastman, and STAYBELITE and STAYBELITE A, each available from PINOVA; (4) a dimerized rosin such as POLY-PALE partially dimerized rosin available from Eastman; and (5) a functionalized rosin resin, for example an ester (e.g., glycerol ester) of a rosin which has been modified with maleic anhydride or a rosin which has been subject to carboxylic acid reduction conditions, with specific mention being made to LEWISOL 28-M and Abitol-E hydroabietyl alcohol, each available from Eastman;
phenol resins (i.e. copolymers of phenolic compounds with formaldehyde), for example novolak resins such as PHENOLITE TD-2131 and PHENOLITE TD-2090 available from DIC Corp.;
polyamide resins, for example VERSAMID 725, 744, 756, 759 available from BASF Japan Ltd., TOHMIDE 90, 92, 394-N available from Sanho Chemical Co. Ltd., and SUNMIDE 550, 554, 615A, 638, 640 available from Evonik;
epoxy resins including sulfonamide-modified epoxy resins for example AD-PRO MTS available from Rit-Chem;
(meth)acrylate and styrene/(meth)acrylate resins for example JONCRYL 63, JONCRYL 67, JONCRYL 586, JONCRYL 611, JONCRYL 682, JONCRYL 693, available from BASF, PARALOID DM-55 and PARALOID B-66, available from Palmer Holland, PARALOID B-72, available from Dow Chemical, USA, and ELVACITE 2013, available from Lucite Inc.;
polyurethane resins, such as those formed from reaction between (i) polyols including, but not limited to, ethylene glycol, propylene glycol, propanediol, butanediol, polyethylene glycol, polypropylene glycol, polytetrahydrofuran diol, 3-methyl-1,5-pentanediol, 1,9-nonanediol, polyester polyols such as polyethylene glycol adipate diol, polyethylene glycol succinate diol, poly(3-methyl-1,5-pentanediol adipate) glycol, poly(3-methyl-1,5-pentanediol terephthalate) glycol, carbonate polyols, and (ii) diisocyanates including, but not limited to, 2,4-toluene diisocyanate, 2,6-toluene diisocyanate, 4,4-diphenylmethane diisocyanate, hexamethylene diisocyanate, and isophorone diisocyanate; for example PERMAX 200, PERMAX 202, and SANCURE 20025F, available from Lubrizol;
polyvinyl butyral resins, for example PIOLOFORM BN 16 and MOWITAL B20H available from Kuraray America, Inc.;
polyhydroxystyrene resins such as poly(p-hydroxy styrene) from DuPont;
vinyl resins, for example UCAR VYHH, VMCH, VMCA, and VAGF, available from Dow Chemical Company, and VINNOL E15/45, H14/36, E15/45M, and E16/40A, available from Wacker Chemie AG, Germany;
formaldehyde resins, including sulfonamide modified formaldehyde resins such as p-toluene sulfonamide formaldehyde resin, melamine formaldehyde resins, sulfonamide-modified melamine formaldehyde resins;
cellulose ester resins such as cellulose acetate butyrate (CAB-551-0.01) available from Eastman;
as well as polyesters, sulfonated polyesters, gums, cellulose ethers, cellulose nitrate resins, polymaleic anhydrides, acetal polymers, styrene/butadiene copolymers, ketone-aldehyde resins, and polyketone resins;
and the like, including mixtures thereof.

In some embodiments, other than the terpene resin (A1), and any optional terpene phenol resin (A2), the inkjet inks are substantially free of additional binder resins/tackifiers/adhesive substances, such as those mentioned above. In some embodiments, the inkjet inks contain a combination of the terpene resin (A1) and the terpene phenol resin (A2), and are preferably substantially free of additional resins, binders, tackifiers, or adhesive substances. In some embodiments, the terpene resin (A1) is the only resin present in the disclosed inkjet inks. In some embodiments, the inkjet inks are substantially free of rosin resins. In some embodiments, the inkjet inks are substantially free of rosin ester resins, partially hydrogenated acidic rosins, dimerized rosins, and other functionalized/modified rosin resins.

### (B) Solvent System

In many printing processes that utilize solvent-based inks, and particularly in thermal inkjet printing, the selection of an appropriate solvent system may impact the reliability of the printing process, the properties/appearance of the printed ink product, and the overall printing process efficiency. For example in thermal inkjet printing, the choice of solvent system may 1) aid bubble formation during the jetting process resulting in reliable ink jetting, 2) affect the stability/volatility of the inkjet inks by changing the interaction dynamics between the solvent(s) and the various inkjet ink components and thus the decap behavior, kogation, running stability, and/or drop trajectory, 3) impact the adhesion, rub and scratch resistance, and optical density properties of the printed image through the interactive forces between the solvent system and the other inkjet ink components even though the solvent(s) may no longer be present, or may be present in lesser amounts, after drying, 4) influence the drying time after application or the equipment needed to dry the applied ink, and/or 5) impact droplet dynamics.

In light of the above, particular preference is given herein to inkjet inks with a solvent system (B) that includes (B1) dioxolane. Dioxolane (1,3-dioxolane) is a heterocyclic acetal with the chemical formula (CH₂)₂O₂CH₂. The inclusion of dioxolane (B1) has been surprisingly found to improve various properties of the inks. Such inks formulated with dioxolane (B1) show excellent decap behavior even up to 60 min decap time, superior print longevity or running stability (e.g. greater than 5,000 pages), and show excellent adhesion on multiple substrates. On the other hand, inkjet inks described herein formulated without dioxolane fail to provide readable images at the shortest tested decap times (30 sec) and poor running stability (less than 1,000 pages).

Dioxolane has also been found to be a unique solvent with respect to solubility/compatibility with the resin(s) (A) as well as the colorant (C) in the disclosed inkjet inks.

The amount of dioxolane (B1) suitable for attaining desirable ink properties (e.g. decap behavior, running stability, adhesion, etc.) may range from preferably at least 2 wt. %, preferably at least 4 wt. %, preferably at least 5 wt. %, preferably at least 10 wt. %, preferably at least 15 wt. %, preferably at least 20 wt. %, preferably at least 25 wt. %, preferably at least 30 wt. %, preferably at least 35 wt. %, more preferably at least 40 wt. %, more preferably at least 45 wt. %, more preferably at least 50 wt. %, even more preferably at least 55 wt. %, yet even more preferably at least 60 wt. %, and preferably up to 98 wt. %, preferably up to 97.5 wt. %, preferably up to 97 wt. %, preferably up to 96.5 wt. %, preferably up to 96 wt. %, preferably up to 95.5 wt. %, preferably up to 95 wt. %, more preferably up to 94.5 wt. %, more preferably up to 94 wt. %, more preferably up to 93.5 wt. %, more preferably up to 93 wt. %, even more preferably up to 92.5 wt. %, even more preferably up to 92 wt. %, even more preferably up to 91.5 wt. %, yet even more preferably up to 91 wt. %, based on a total weight of the inkjet ink.

The solvent system (B) may also optionally include (B2) an alcohol solvent. The inclusion of the alcohol solvent (B2) may be beneficial to aid solvation of the inkjet ink components, particularly when a terpene phenol resin (A2) is employed, and to aid jettability, among other benefits.

The alcohol solvent (B2) may contain at least 1 carbon atom, preferably at least 2 carbon atoms, more preferably at least 3 carbon atoms, and up to 8 carbon atoms, preferably up to 6 carbon atoms, more preferably up to 4 carbon atoms. Preferred alcohol solvents (B2) are those which have a boiling point of preferably less than 120° C., preferably less than 115° C., preferably less than 110° C., more preferably less than 105° C., even more preferably less than 100° C., yet even more preferably less than 98° C.

Suitable examples of alcohol solvents which may be used singly or in combination in the disclosed inkjet inks include, but are not limited to, methanol, ethanol, 1-propanol, 2-propanol, 1-butanol, 2-butanol, 2-pentanol, 3-pentanol, and t-amyl alcohol, with specific mention being made to 1-propanol.

When employed, the alcohol solvent (B2) may be present in the inkjet inks in an amount of preferably at least 0.5 wt. %, preferably at least 0.75 wt. %, preferably at least 1 wt. %, preferably at least 1.25 wt. %, preferably at least 1.5 wt. %, preferably at least 1.75 wt. %, preferably at least 2 wt. %, wt. %, preferably at least 2.25 wt. %, preferably at least 2.5 wt. %, preferably at least 2.75 wt. %, preferably at least 3 wt. %, preferably at least 3.25 wt. %, preferably at least 3.5 wt. %, preferably at least 3.75 wt. %, preferably at least 4 wt. %, preferably at least 4.25 wt. %, preferably at least 4.5 wt. %, wt. %, preferably at least 4.75 wt. %, preferably at least 5 wt. %, and preferably up to 60 wt. %, preferably up to 55 wt. %, preferably up to 50 wt. %, preferably up to 45 wt. %, preferably up to 40 wt. %, more preferably up to 37.5 wt. %, more preferably up to 35 wt. %, even more preferably up to 34.5 wt. %, even more preferably up to 34 wt. %, even more preferably up to 33.5 wt. %, even more preferably up to 33 wt. %, even more preferably up to 32.5 wt. %, even more preferably up to 32 wt. %, even more preferably up to 31.5 wt. %, even more preferably up to 31 wt. %, yet even more preferably up to 30.75 wt. %, yet even more preferably up to 30.5 wt. %, yet even more preferably up to 30.25 wt. %, yet even more preferably up to 30 wt. %, based on a total weight of the inkjet ink.

In preferred embodiments, the dioxolane (B1) together with the alcohol solvent (B2) constitute a majority of the solvent system (B) used in the inkjet inks, i.e., the combined weight of the dioxolane (B1) and alcohol solvent (B2) may range from preferably at least 50 wt. %, preferably at least 60 wt. 00 more preferably at least 70 wt. %, preferably at least 80 wt. %, preferably at least 90 wt. 00 preferably at least 95 wt. %, preferably at least 96 wt. %, preferably at least 98 wt. %, more preferably at least 99 wt. %, even more preferably at least 99.5 wt. %, yet even more preferably 100 wt. % based on a total weight of the solvent system (B).

Relative to dioxolane (B1), preferred inkjet inks are those having a weight ratio of dioxolane (B1) to the alcohol solvent (B2) ((B1):(B2)) of from preferably 0.25:1, preferably from 0.5:1, preferably from 0.75:1, preferably from 1:1, preferably from 1.25:1, more preferably from 1.5:1, even more preferably from 1.75:1, yet even more preferably from 2:1, and preferably up to 30:1, preferably up to 25:1, preferably up to 20:1, preferably up to 17.5:1, preferably up to 15:1, preferably up to 12.5:1, preferably up to 10:1, preferably up to 7.5:1, preferably up to 5:1, more preferably up to 4.5:1, even more preferably up to 4:1, yet even more preferably up to 3.5:1.

Relative to terpene resin (A1), preferred inkjet inks are those having a weight ratio of dioxolane (B1) to the terpene resin (A1) ((B1):(A1)) ranging from preferably at least 20:1, preferably at least 25:1, preferably at least 30:1, preferably at least 35:1, preferably at least 40:1, preferably at least 45:1, preferably at least 50:1, preferably at least 55:1, preferably at least 60:1, preferably at least 65:1, preferably at least 70:1, preferably at least 75:1, more preferably at least 80:1, even more preferably at least 85:1, yet even more preferably at least 90:1, and preferably up to 250:1, preferably up to 225:1, preferably up to 200:1, preferably up to 175:1, preferably up to 150:1, more preferably up to 125:1, more preferably up to 120:1, more preferably up to 115:1, more preferably up to 110:1, even more preferably up to 105:1, yet even more preferably up to 100:1.

While the amount of alcohol solvent (B2) can be adjusted, for example to provide the desired levels of solvation, preferred inkjet inks are those having a weight ratio of terpene resin (A1) to alcohol solvent (B2) ((A1):(B2)) ranging from preferably at least 1:75, preferably at least 1:70, preferably at least 1:65, preferably at least 1:60, preferably at least 1:55, preferably at least 1:50, preferably at least 1:45, preferably at least 1:40, preferably at least 1:35, preferably at least 1:30, more preferably at least 1:27.5, more preferably at least 1:25, more preferably at least 1:22.5, even more preferably at least 1:20, yet even more preferably at least 1:19, and preferably up to 1:2, preferably up to 1:5, preferably up to 1:7.5, preferably up to 1:10, more preferably up to 1:12.5, more preferably up to 1:15, more preferably up to 1:17.5, more preferably up to 1:18.5.

In addition to those solvents mentioned above, the solvent system may also optionally include one or more other organic solvents.

Examples of other organic solvents include, but are not limited to,
alcohols excluding the alcohol solvent (B2) such as 2-methyl-1-butanol, undecanols (e.g., 1-undecanol), dodecanols (e.g., 1-dodecanol), tridecanols (e.g., 1-tridecanol), tetradecanols (e.g., 1-tetradecanol), including terpene alcohols such as monoterpene alcohols (e.g., terpineol, geraniol, citronellol, linalool, etc.);
polyols such as trimethylene glycol, 1,2-hexanediol, and glycerol.
glycol ethers including monoalkyl glycol ethers, dialkyl glycol ethers, and monoalkyl monoester glycol ethers, such as ethylene glycol monomethyl ether, ethylene glycol monoethyl ether, ethylene glycol mono-isopropyl ether, ethylene glycol mono-n-propyl ether, ethylene glycol mono-t-butyl ether, ethylene glycol monobutyl ether, ethylene glycol mono-isobutyl ether, diethylene glycol monomethyl ether, propylene glycol monomethyl ether, propylene glycol monoethyl ether, propylene glycol mono-t-butyl ether, propylene glycol mono-n-propyl ether, propylene glycol mono-isopropyl ether, propylene glycol mono-n-butyl ether, dipropylene glycol monomethyl ether, propylene glycol methyl ether acetate, ethylene glycol dimethylether, diethylene glycol dimethylether, diethylene glycol methyl ethyl ether, diethylene glycol diethylether, dipropylene glycol dimethyl ether, dipropylene glycol mono-n-propyl ether;
ethers (non-glycol ethers) such as diethyl ether, dipropyl ether, methyl tert-butyl ether, and tetrahydrofuran, dibutyl ether and dioxane;
ketone solvents such as acetone, methyl ethyl ketone (MEK), methyl isopropyl ketone, 3-pentanone, methyl n-propyl ketone, ethyl isopropyl ketone, methyl isobutyl ketone, cyclohexanone, diacetone alcohol, 3-hexanone, and methyl n-butyl ketone;
esters such as methyl acetate, ethyl acetate, n-butyl acetate, methyl lactate, ethyl lactate, butyl lactate, methoxyethyl acetate, ethoxyethyl acetate, methoxypropyl acetate, and ethoxypropyl acetate;
amides such as dimethylformamide and dimethylacetamide;
acetonitrile
as well as mixtures of two or more thereof.

The other organic solvent(s) may be used in any amount desired for a particular application, with typical loadings ranging preferably up to 20 wt. %, preferably up to 15 wt. %, preferably up to 10 wt. %, preferably up to 5 wt. %, more preferably up to 4 wt. %, even more preferably up to 2 wt. %, yet even more preferably up to 1 wt. %, based on a total weight of the inkjet inks, though higher loadings may sometimes be used. In some embodiments, the inkjet inks are substantially free of other organic solvents.

In some embodiments, the inkjet inks are substantially free of solvents having a boiling point preferably higher than 255° C., preferably solvents having a boiling point higher than 250° C., preferably solvents having a boiling point higher than 245° C., preferably solvents having a boiling point higher than 240° C., preferably solvents having a boiling point higher than 235° C., preferably solvents having a boiling point higher than 230° C., preferably solvents having a boiling point higher than 220° C., preferably solvents having a boiling point higher than 210° C., more preferably solvents having a boiling point higher than 200° C., even more preferably solvents having a boiling point higher than 195° C. In some embodiments, the inkjet inks are substantially free of ketone solvents having a boiling point of 120° C. or greater, examples of which include but are not limited to, 3-hexanone, methyl n-butyl ketone, and cyclohexanone.

In some embodiments, the inkjet inks are substantially free of ketone solvents which have a boiling point of preferably less than 120° C., preferably less than 115° C., preferably less than 110° C., preferably less than 105° C., preferably less than 100° C., preferably less than 95° C., more preferably less than 90° C., even more preferably less than 85° C., yet even more preferably less than 80° C. Such ketone solvents may contain 3, 4, 5, or 6 carbon atoms. Examples of such ketone solvents, include, but are not limited to, acetone, methyl ethyl ketone (MEK), 3-pentanone, methyl n-propyl ketone, methyl isopropyl ketone, ethyl isopropyl ketone, and methyl isobutyl ketone. In some embodiments, the inkjet inks are substantially free of methyl ethyl ketone. In some embodiments, the inkjet inks are devoid of methyl ethyl ketone.

The solvent system (B) may also optionally include a glycol ether to further improve decap performance without substantially worsening ink dry times. The glycol ether may be a monoalkyl ether, a dialkyl ether, a monoalkyl monoester ether, or a combination thereof, preferably the glycol ether is a monoalkyl monoester ether, i.e., a glycol compound where one hydroxyl group is etherified and the other hydroxyl group is esterified. The glycol ether may contain preferably at least 3 carbon atoms, preferably at least 4 carbon atoms, more preferably at least 5 carbon atoms, even more preferably at least 6 carbon atoms, and preferably up to 12 carbon atoms, preferably up to 10 carbon atoms, more preferably up to 8 carbon atoms.

In some embodiments, the solvent system (B) may be formulated with a mixture of glycol ethers, for example, a first glycol ether and a second glycol ether in a weight ratio of preferably at least 1:5, preferably at least 1:4, more preferably at least 1:3, even more preferably at least 1:2, yet even more preferably at least 1:1, and preferably up to 5:1, preferably up to 4:1, more preferably up to 3:1, even more preferably up to 2:1.

Acceptable examples of glycol ethers that may be optionally included in the disclosed inkjet inks include, but are not limited to, ethylene glycol monomethyl ether, ethylene glycol monoethyl ether, ethylene glycol mono-isopropyl ether, ethylene glycol mono-n-propyl ether, ethylene glycol mono-t-butyl ether, ethylene glycol monobutyl ether, ethylene glycol mono-isobutyl ether, diethylene glycol monomethyl ether, propylene glycol monomethyl ether, propylene glycol monoethyl ether, propylene glycol mono-t-butyl ether, propylene glycol mono-n-propyl ether, propylene glycol mono-isopropyl ether, propylene glycol mono-n-butyl ether, dipropylene glycol monomethyl ether, ethylene glycol mono-n-butyl ether acetate, propylene glycol methyl ether acetate, diethylene glycol mono-n-butyl ether acetate, diethylene glycol monoethyl ether acetate, ethylene glycol dimethylether, diethylene glycol dimethylether, diethylene glycol methyl ethyl ether, diethylene glycol diethylether, dipropylene glycol dimethyl ether, dipropylene glycol mono-n-propyl ether, as well as mixtures thereof.

In terms of improving decap performance of the inkjet inks without considerably lengthening ink dry times, preferred glycol ethers are those which have a boiling point of preferably less than 214° C., preferably less than 210° C., more preferably less than 205° C., even more preferably less than 200° C., yet even more preferably less than 195° C.

In light of the above, preference is given to ethylene glycol mono-n-butyl ether acetate, ethylene glycol monomethyl ether, propylene glycol monomethyl ether, ethylene glycol mono-n-propyl ether, and propylene glycol mono-n-propyl ether, with specific mention being made to ethylene glycol mono-n-butyl ether acetate.

When employed, the glycol ether may be present in the inkjet inks in an amount of preferably at least 0.1 wt. %, preferably at least 0.3 wt. %, preferably at least 0.5 wt. %, preferably at least 0.7 wt. %, more preferably at least 1 wt. %, even more preferably at least 1.5 wt. %, yet even more preferably at least 2 wt. %, and preferably up to 20 wt. %, preferably up to 15 wt. %, more preferably up to 10 wt. %, even more preferably up to 5 wt. %, yet even more preferably up to 3 wt. %, based on a total weight of the inkjet ink. In some embodiments, the inkjet inks are substantially free of glycol ethers.

In some embodiments, the inkjet inks are substantially free of alcohol solvents (B2).

In preferred embodiments, the solvent system (B) consists of dioxolane (B1), and an alcohol solvent (B2).

In preferred embodiments, the inkjet inks of the present disclosure are substantially non-aqueous, meaning that no water is added to the inkjet inks other than what may be incidental amounts of moisture derived from ambient conditions. In such cases, the inkjet inks may have preferably less than 1 wt. %, preferably less than 0.5 wt. %, preferably less than 0.1 wt. %, more preferably less than 0.05 wt. %, even more preferably less than 0.01 wt. % of water, yet even more preferably 0 wt. %, based on the total weight of inkjet inks.

### (C) Colorant

The inkjet inks of the present disclosure comprise a colorant comprising a metal complex azo dye. In this context, the term “metal complex azo dye” refers to a dye which comprises a compound formed from a metal center and a ligand which comprises an azo functional group (also known as a diazenyl functional group). Typically, the ligand which comprises an azo functional group is a molecule which itself may be considered an azo dye.

This ligand which comprises an azo functional group is coordinated to a metal center, typically a transition metal or main-group metal or metalloid but not an alkali metal or alkaline earth metal.

Examples of suitable metals which may form the metal center include, but are not limited to titanium, vanadium, chromium, manganese, iron, cobalt, nickel, copper, zinc, zirconium, niobium, molybdenum, ruthenium, rhodium, cadmium, aluminum, indium, tin, bismuth, and mixtures thereof. Such coordination may be through any suitable functional group present on the ligand. Examples of such functional groups include, but are not limited to oxygen-containing functional groups such as alcohols, alkoxides, carboxylic acids and carboxylates, esters, ketones, and ethers; nitrogen-containing functional groups such as amine, amide, azide, diazenyl (azo groups), imine, porphyrin, imide, isonitrile, nitrile, and nitro functional groups; phosphorous-containing functional groups such as phosphine, phosphite, phosphate, phosphonite, phosphonate, phosphinite, and phosphinate functional groups; and sulfur-containing functional groups such as thiol, thiolate, disulfide, sulfone, sulfonic acid and sulfonate, sulfoxide, thial, thioester, thiosulfinate, thiocarboxylic acid and thiocarboxylate, sulfinic acid and sulfonate, thiocyanate, and isothiocyanate functional groups. The ligand coordinated to the metal center may be monodentate or bidentate, tridentate or tetradentate. Typically, ligands which comprise an azo group as used herein form a coordination interaction to the metal center through one or both of the nitrogen atoms which form the azo group.

In general, the rest of the inner coordination sphere of the metal center may be further filled by any suitable ligand or combination of ligands known to one of ordinary skill in the art. Examples of suitable ligands include species with oxygen-containing functional groups such as alcohols, alkoxides, hydroxides, carboxylic acids and carboxylates, esters, and ethers; species with nitrogen-containing functional groups such as amines (understood here to include ammonia), amides, azides, other diimides (also known as azo compounds), imines, porphyrins, imides, isonitriles, nitriles, and nitro compounds; species with phosphorous-containing functional groups such as phosphines, phosphites, phosphates, phosphonites, phosphonates, phosphinites, and phosphinates; species with sulfur-containing functional groups such as thiols, thiolates, disulfides, sulfones, sulfonic acids and sulfonates, sulfoxides, thials, thioesters, thiosulfinates, thiocarboxylic acids and thiocarboxylates, sulfinic acids and sulfinates, thiocyanates, and isothiocyanates; hydrocarbons containing one or more π-electron systems such as mesitylene, cyclopentadienyl anion, and cyclooctadecene; halides; and water. In general, the ligands, may be monodentate, bidentate, tridentate, tetradentate, or pentadentate as appropriate. Hexadentate ligands, however, such as ethylenediamine tetraacetic acid (EDTA) are not suitable as such ligands do not leave an open coordination site for coordination of a suitable ligand which comprises an azo functional group. In general, the functional groups may occupy any suitable location on a molecule which acts as a ligand. For example, alcohols or amines may be primary alcohols or amines, secondary alcohols or amines, or tertiary alcohols or amines as appropriate.

In preferred embodiments, the metal complex azo dye is a metal complex comprising a metal center and (E)-1-((2-methoxy-5-nitrophenyl)diazenyl)naphthalen-2-ol or a deprotonated form, demethylated form, deprotonated and demethylated form, tautomer, or stereoisomer thereof. The structure of (E)-1-((2-methoxy-5-nitrophenyl)diazenyl)naphthalen-2-ol is shown in Formula 1, below:

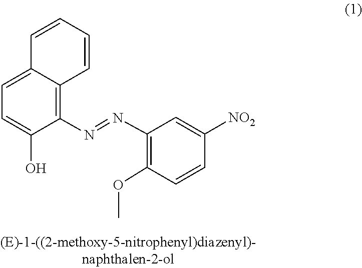 [SMILES: COc1ccc([N+](=O)[O-])cc1/N=N/c1c(O)ccc2ccccc12]

To form a suitable metal complex, the and (E)-1-((2-methoxy-5-nitrophenyl)diazenyl)naphthalen-2-ol may exist in a deprotonated form, in which the hydroxyl group is deprotonated to form an alkoxide type ligand (see Formula (2) below), a demethylated form in which the methoxy group has been converted to an alkoxide type ligand (see Formula (3) below), or a deprotonated and demethylated form in which the hydroxyl group is deprotonated to form an alkoxide type ligand and the methoxy group has been converted to an alkoxide type ligand (see Formula (4) below).

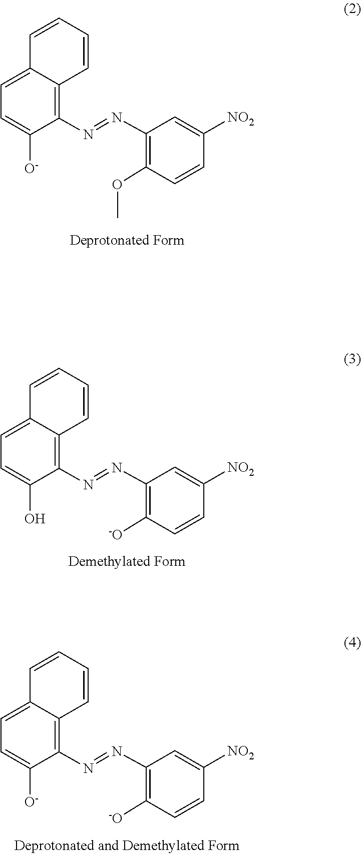

In preferred embodiments, the metal center is a chromium ion. In some embodiments, the chromium ion is in the +3 oxidation state. In such embodiments, the metal complex may have a positive charge, a negative charge, or have no charge. In embodiments in which the metal complex has a positive charge, the metal complex azo dye may further comprise any suitable anion for charge balance. Examples of such suitable anions include, but are not limited to carboxylates, halides, sulfates, phosphates, hydrogen phosphates, dihydrogen phosphates, nitrates, and mixtures thereof. In embodiments in which the metal complex has a negative charge, the metal complex azo dye may further comprise any suitable cation for charge balance. Examples of such suitable cations include, but are not limited to alkali metals, alkaline earth metals, ammonium compounds, and mixtures thereof.

Preferably, the coordination between the metal and the ligand which comprises an azo functional group generates an electric dipole. The presence of such an electric dipole may be advantageous for causing a strong interaction between the metal complex azo dye and the polar solvent like dioxolane (B1). Further, the metal complex azo dye preferably comprises a portion, for example another functional group that is hydrophobic. The presence of such a hydrophobic portion may be advantageous for giving the metal complex azo dye sufficient interaction with terpene resin (A1). Using such a metal azo complex as a mediator may be particularly advantageous for inkjet inks of the present application as the combination of terpene resin(A1) and dioxolane (B) are among the main factors that produce the quick ‘skin’ or ‘film’ formation of the present invention.

Examples of suitable metal complex azo dyes include, but are not limited to Solvent Black 27, Solvent Black 28, Solvent Black 29, Solvent Black 34, Solvent Blue 137, Solvent Brown 37, Solvent Brown 42, Solvent Brown 43, Solvent Brown 52, Solvent Orange 54, Solvent Red 8, Solvent Red 109, Solvent Red 119, Solvent Yellow 19, Solvent Yellow 21, Solvent Yellow 25, Solvent Yellow 82, Solvent Yellow 88, Solvent Yellow 146, Solvent Violet 58, Solvent Violet 61, as well as VALIFAST BLACK 3870, VALIFAST RED 1355, and VALIFAST YELLOW 3150 each available from Orient Chemical Industries Co., Ltd., with special mention being made to Solvent Black 27 (also sold under VALIFAST BLACK 3830 available from Orient Chemical Industries Co., Ltd).

The amounts of colorants (C) suitable for attaining desirable ink properties (e.g. decap behavior, running stability, adhesion, etc.) may range from preferably at least 0.5 wt. %, preferably at least 1 wt. %, preferably at least 3 wt. %, preferably at least 5 wt. %, preferably at least 7 wt. %, and preferably up to 20 wt. %, preferably up to 15 wt. %, preferably up to 12 wt. %, preferably up to 10 wt. %, preferably up to 9 wt. %, relative to a total weight of the inkjet inks.

The amounts of the metal azo dye suitable for attaining desirable ink properties (e.g. decap behavior, running stability, adhesion, etc.) may range from preferably at least 0.5 wt. %, preferably at least 1 wt. %, preferably at least 3 wt. %, preferably at least 5 wt. %, preferably at least 7 wt. %, and preferably up to 20 wt. %, preferably up to 15 wt. %, preferably up to 12 wt. %, preferably up to 10 wt. %, preferably up to 9 wt. %, relative to a total weight of the inkjet inks.

The colorants (C) may be included in the inkjet ink to provide any desired color, including dyes other than the metal complex azo dye or pigments, as colorants (C2). Colorants (C2) can be provided that the colorant can be dissolved or stably dispersed within the inkjet inks. Suitable colors include, for example, cyan, magenta, yellow, and key (black) (“CMYK”), white, orange, green, light cyan, light magenta, violet, and the like, including both spot colors and process colors.

In general, the additional colorants (C2) may be employed, when used, in amounts of preferably at least 0.1 wt. %, preferably at least 0.5 wt. %, preferably at least 1 wt. %, preferably at least 2 wt. %, preferably at least 3 wt. %, and preferably up to 10 wt. %, preferably up to 8 wt. %, preferably up to 7 wt. %, preferably up to-6 wt. %, preferably up to 5 wt. %, relative to a total weight of the inkjet inks.

The weight of the metal azo dye suitable for attaining desirable ink properties (e.g. decap behavior, running stability, adhesion, etc.) may range from preferably at least 50 wt. 00 preferably at least 75 wt. 00 preferably at least 95 wt. %, preferably at least 98 wt. %, preferably at least 99 wt. 00 and preferably 100 wt. %. based on a total weight of the colorants (C).

The inkjet inks can be formulated with various inorganic pigments and/or organic pigments. In addition to providing color to the inkjet inks, such pigments may be capable of improving the light resistance, the weather resistance, etc., of the printed images.

### (D) Surfactant

The inkjet inks of the present disclosure may optionally include (D) a surfactant, for example, to provide anti-blocking, ink acceptance, levelling, anti-cratering, increased surface slip, and/or substrate wetting properties, among other benefits, without sacrificing inkjet ink decap performance. When employed, the amount of surfactant (D) used may range from preferably at least 0.01 wt. %, preferably at least 0.015 wt. %, preferably at least 0.02 wt. %, preferably at least 0.04 wt. %, more preferably at least 0.06 wt. %, even more preferably at least 0.08 wt. %, even more preferably at least 0.1 wt. %, even more preferably at least 0.15 wt. %, even more preferably at least 0.2 wt. %, even more preferably at least 0.25 wt. %, even more preferably at least 0.3 wt. %, even more preferably at least 0.35 wt. %, even more preferably at least 0.4 wt. %, even more preferably at least 0.45 wt. %, even more preferably at least 0.5 wt. %, and preferably up to 5 wt. %, preferably up to 4 wt. %, preferably up to 3 wt. %, preferably up to 2 wt. %, preferably up to 1 wt. %, preferably up to 0.95 wt. %, preferably up to 0.9 wt. %, even more preferably up to 0.85 wt. %, even more preferably up to 0.8 wt. %, based on a total weight of the inkjet ink.

Examples of surfactants (D) which may be used herein, singly or in combination, include, but are not limited to,
polysiloxanes including organomodified silicones (e.g., alkyl, aryl, and/or arylalkyl modified silicones) such as SILTECH C-32, available from Siltech Corporation, COATOSIL 1211C and 3573, each available from Momentive, KF-410 (an arylalkyl-modified polydimethylsiloxane), available from Shin-Etsu Chemical Co., and BYK-322 and BYK-323 (arylalkyl-modified poly(dimethylsiloxane-co-methylalkylsiloxane)), each available from BYK Additives & Instruments;
silicone acrylate copolymers such as KP-541, KP-543, KP-545, KP-550, and KP-575 (acrylic polymers grafted with polydimethylsiloxane side chains, available from Shin-Etsu Chemical Co., Ltd.), and BYK-3550 (available from BYK Japan K.K.);
polyether modified silicones, including those which are block copolymers having a pendent graft structure formed from a linear or branched polydimethylsiloxane backbone containing one or more polyether side chains and optionally one or more fatty alkyl side chains;
fluoropolymers such as FC-4430 and FC-4432, available from 3M Corporation;
polyether modified silicones, including those which are block copolymers having a pendent graft structure formed from a linear or branched polydimethylsiloxane backbone containing one or more polyether side chains and optionally one or more fatty alkyl side chains, such as KF-6013 (PEG-9 dimethicone, uncapped, HLB=10.0), KF-6015 (PEG-3 dimethicone, uncapped, HLB=4.5), KF-6017 (PEG-10 dimethicone, uncapped, HLB=4.5), and KF-6038 (Lauryl PEG-9 poly dimethylsiloxyethyl dimethicone, uncapped, HLB=3.0), each available from Shin-Etsu Chemical Co., and BYK-307 (polyether modified polydimethylsiloxane), available from BYK Additives & Instruments;
photo-cross-linkable silicone acrylates or silicone polyether acrylates such as TEGO RAD 2100, TEGO RAD 2200, TEGO RAD 2250, TEGO RAD 2300 (silicone polyether acrylate), each available from Evonik Industries, and BYK-UV 3500 and 3530, available from BYK;
polyacrylates including polyacrylate copolymers and cross-polymers such as BYK-381 and BYK-361N (polyacrylate copolymer), each available from BYK, PEMULEN EZ-4U (acrylate/C10-C30 alkyl acrylate crosspolymer) and PEMULEN TR-2 (acrylic acid/C10-C30 alkyl acrylate crosspolymer), each available from Lubrizol;
acetylenic diol and acetylenic glycol-based gemini surfactants such as SURFYNOL SEF and DYNOL surfactants, available from Evonik Industries;
polysiloxane-based gemini surfactants such as TEGO TWIN 4100, available from Evonik Industries;
non-ionic polyethers for example as substrate wetting surfactants such as TEGO WET 510 (hydrophilic polyether substrate wetting surfactant), available from Evonik Industries;
amides or monoalkanolamides of fatty acids, including alkoxylated monoalkanolamides of fatty acids such as coconut fatty acid monoethanolamide and coconut fatty acid monoethanolamide reacted with 2-20 moles of ethylene oxide;
ethers, such as alkoxylated C1-C22 alcohols including alkoxylated fatty alcohols such as BIO-SOFT N-600 (C12-C13 alcohol ethoxylate), MAKON DA-4 (ethoxylated isodecyl alcohol), MERPOL SE (alcohol ethoxylate), and POLYSTEP TD-6 (ethoxylated tridecyl alcohol), each available from Stepan, ethylene oxide/propylene oxide copolymers, alkoxylated alkylphenols, and alkyl polyglycosides (APGs) such as those made from reaction between fatty alcohols and glucose;
fatty esters such as ethoxylated and/or propoxylated fatty acids (e.g., castor oil with 2 to 40 moles of ethylene oxide), alkoxylated glycerides (e.g., PEG-24 glyceryl monostearate), glycol esters and derivatives, monoglycerides, polyglyceryl esters, esters of polyalcohols, and sorbitan/sorbitol esters like sorbitan monolaurate (e.g., EMASOL L-10V, available from Kao) and polysorbates including mono-, bi- or tri-fatty acid esterified polysorbates such as TOXIMUL SEE-340 (sorbitan trioleate ethoxylate (20)), available from Stepan;
glycosides of fatty alcohols such as PLANTASENS NATURAL EMULSIFIER HE20 (cetearyl glucoside, sorbitan olivate), available from Clariant;
sulfates, sulfonates, phosphates, and phosphonates, such as alkyl sulfates, alkyl-ester-sulfates, alkyl ether sulfates, alkyl-alkoxy-ester-sulfate, sulfated alkanolamides, glyceride sulfates, alkyl sulfonates, fatty alkyl-benzene sulfonates, lower alkyl-benzene sulfonates, alpha olefin sulfonates, lignosulfonates, alkyl aryl ether phosphates, alkyl ether phosphates, and phosphates of fatty alcohols or polyoxyalkylene ethers of fatty alcohols; and
amphoteric surfactants including, but not limited to: fatty alkyl betaines such as lauryl betaine (e.g., AMPHITOL 24B, available from Kao); fatty alkyl amido betaines such as fatty amidopropyl dimethylamino betaine; fatty alkyl sultaines such as fatty dimethyl hydroxysultaine; fatty alkyl amido sultaines such as fatty amido propyl dimethylamino hydroxysultaine; amine oxides, such as N-cocoamidopropyl dimethyl amine oxide, dimethyl fatty alkyl amine oxides such as dimethyl coco amine oxide, lauryldimethyl amine oxide (e.g., AMPHITOL 20N, available from Kao); and imidazole-based amphoteric surfactants (e.g., ELEC AC, available from Kao).

When the inkjet inks are formulated with a surfactant (D), a particularly preferred surfactant is a silicone acrylate copolymer. The silicone acrylate copolymer may be obtained according to methods known to those of ordinary skill in the art, for example, by polymerization (e.g., free-radical polymerization) or grafting of a polyorganosiloxane macromer comprising at least one polymerizable group (e.g., on one of the ends of the polyorganosiloxane chain, on both ends of the polyorganosiloxane chain, or on the silicone backbone) and a (meth)acrylate monomer, as described for example, in U.S. Pat. No. 5,219,560-incorporated herein by reference in its entirety. Preferably, the silicone acrylate copolymer is a polysiloxane (polyorganosiloxane) modified poly(meth)acrylate, that is, a copolymer composed of a poly(meth)acrylate backbone and one or more polyorganosiloxane side chains grafted to the poly(meth)acrylate backbone (i.e., a graft copolymer). In preferred embodiments, a major proportion of the silicone acrylate copolymer is poly(meth)acrylate. In preferred embodiments, the silicone acrylate copolymer has a polyorganosiloxane content of preferably at least 1 wt. %, preferably at least 2 wt. %, more preferably at least 3 wt. %, even more preferably at least 4 wt. %, and preferably up to 20 wt. %, preferably up to 15 wt. %, more preferably up to 10 wt. %, even more preferably up to 8 wt. %, based on a total weight of the silicone acrylate copolymer.

The polyorganosiloxane macromer may be based on any organosilicon polymer or oligomer of linear structure, of variable molecular weight, which can be formed from polymerization and/or poly condensation of suitably functionalized silanes, and which has a polysiloxane backbone structure (silicon atoms are linked together via oxygen atoms, —Si—O—Si—), with alkyl, aryl, and/or arylalkyl groups directly bonded to the (tetravalent) silicon atoms. For example, the polyorganosiloxane backbone may be a polydimethylsiloxane backbone (where each silicon atom in the backbone is directly bonded to two methyl groups), a poly(dimethylsiloxane-co-methylphenylsiloxane) backbone, a poly(dimethylsiloxane-co-diphenylsiloxane) backbone, or a poly(dimethylsiloxane-co-methylalkylsiloxane) backbone.

The polyorganosiloxane macromer may be modified to include at least one polymerizable group (e.g., (meth)acrylate-containing group), preferably the polyorganosiloxane macromer may be end group modified to include a polymerizable group on at least one of the ends of the polysiloxane chain. In some embodiments, the polyorganosiloxane macromer has a polymerizable group on both ends of the polysiloxane chain. In some embodiments, the polyorganosiloxane macromer has a polymerizable group on one end of the polysiloxane chain and a non-polymerizable end group (e.g., trimethyl silane, triphenyl silane, phenyldimethylsilane, etc.) on the other end of the chain. In some embodiments, the polymerizable group may be a styrenyl-type group (CH₂═C(R₁)-arylene-) or a (meth)acrylate group, in particular a group represented by CH₂═CR₁—CO—O—R₂—, wherein R₁ is a hydrogen or a methyl group and R₂ is a divalent, linear or branched hydrocarbon group having preferably 1 to 10 carbon atoms, preferably 2 to 8 carbon atoms, preferably 3 to 6 carbon atoms, and optionally containing ether bonds therein (e.g., one, two, three, four, etc. ether bonds), and optionally containing hydroxyl group substituent(s) (e.g., as in the case of ring-opened products resulting from reaction between an epoxide and (meth)acrylic acid). In preferred embodiments, R₂ is —(CH₂)ₙ— with n=1 to 10, —CH₂CH(CH₃)CH₂—, —CH₂CH₂OCH₂CH₂—, —CH₂CH₂OCH₂CH₂CH(CH₃)CH₂—, —CH₂CH₂OCH₂CH₂OCH₂CH₂CH₂—, and —CH₂CH(OH)CH₂OCH₂CH₂CH₂—.

The silicone acrylate copolymer may be made by polymerizing the polyorganosiloxane macromer in the presence of a wide variety of (meth)acrylate monomers, such as those (meth)acrylate monomers mentioned previously, including both (meth)acrylic acid (acrylic acid and methacrylic acid) and ester variants, which may be aryl or alkyl (meth)acrylate esters. The poly(meth)acrylate backbone may be formed from one type of monomer, or alternatively from two or more types of (meth)acrylate monomers. In preferred embodiments, the (meth)acrylate monomers are (meth)acrylate alkyl esters, which may be chosen from linear, branched or cyclic alkyl esters, for example C₁ to C₂₂ alkyl esters, preferably C₂ to C₂₀ alkyl esters, preferably C₃ to C₁₈ alkyl esters of acrylates and methacrylates. In some embodiments, the alkyl group is chosen from methyl, ethyl, butyl, stearyl, isostearyl, and 2-ethylhexyl, as well as mixtures thereof. Suitable (meth)acrylate monomers include, but are not limited to, methyl acrylate, ethyl acrylate, isopropyl acrylate, n-butyl acrylate, tert-butyl acrylate, cyclohexyl acrylate, 2-ethylhexyl acrylate, tridecyl acrylate, stearyl acrylate, isostearyl acrylate, behenyl acrylate, methyl methacrylate, ethyl methacrylate, isopropyl methacrylate, n-butyl methacrylate, tert-butyl methacrylate, cyclohexyl methacrylate, 2-ethylhexyl methacrylate, tridecyl methacrylate, stearyl methacrylate, isostearyl methacrylate, behenyl methacrylate, and combinations thereof.

In some embodiments, the silicone acrylate copolymer has a weight average molecular weight of preferably from 3,000 g/mol, preferably from 4,000 g/mol, more preferably from 5,000 g/mol, even more preferably from 8,000 g/mol, yet even more preferably from 10,000 g/mol, and preferably up to 500,000 g/mol, preferably up to 400,000 g/mol, more preferably up to 300,000 g/mol, even more preferably up to 200,000 g/mol, yet even more preferably up to 100,000 g/mol.

When employed in the inkjet inks, the silicone acrylate copolymer may be used as is or, alternatively, may be dispersed or dissolved in an organic solvent such as lower alcohols containing from 2 to 8 carbon atoms (e.g., ethanol, 1-proponol, 2-propanol, 1-butanol, etc.), ester solvents (e.g., methoxyethyl acetate, ethoxyethyl acetate, methoxypropyl acetate, ethoxypropyl acetate, butyl acetate, etc.) or oils (e.g., cyclopentasiloxane). In some embodiments, when employed as a dispersion or solution, the solvent is an ester solvent, most preferably methoxypropyl acetate. In some embodiments, the solids (silicone acrylate copolymer) content of the dispersion or solution is preferably at least 30 wt. %, preferably at least 40 wt. %, preferably at least 50 wt. %, and preferably up to 60 wt. %, preferably up to 55 wt. %, preferably up to 52 wt. %, relative to a total weight of the dispersion/solution.

Representative examples of silicone acrylate copolymers that are commercially available and which may be used in the inkjet inks described herein include, but are not limited to, KP-541, KP-543, KP-545, KP-550, KP-575 (acrylic polymers grafted with polydimethylsiloxane side chains, available from Shin-Etsu Chemical Co., Ltd.), BYK-3550 (available from BYK Japan K.K.), including mixtures thereof. In preferred embodiments, the silicone acrylate copolymer is BYK-3550.

In some embodiments, the inkjet inks of the present disclosure are substantially free of surfactants, such as those listed above.

### (E) Additive(s)

In addition to the components already mentioned, the inkjet inks may also optionally be formulated with various additives (E) to improve various ink characteristics and performance. For example, the inkjet inks may optionally contain one or more of an anti-kogation agent, a stabilizer, a humectant, a security taggant, or other inkjet ink additive(s) known by those of ordinary skill in the art, in art appropriate levels.

The inkjet inks may optionally contain one or more opacifying agents, examples of which may include, but are not limited to, titanium dioxide, zirconium silicate, zirconium oxide, tin oxide, cerium oxide, zinc oxide, aluminum oxide, silica, kaolin, calcium carbonate, magnesium carbonate, calcium magnesium carbonate, barium carbonate, sodium feldspar, potassium feldspar, nepheline, calcium silicate, mullite, wollastonite, and talc.

### Methods of Making

Embodiments of the inkjet inks described herein may be prepared by any suitable technique known to those of ordinary skill in the art, for example by combining (A1) a terpene resin and (C) a colorant and any desired optional ingredients (e.g., (A2) terpene phenol resin, surfactant (D), and/or an additive (E)) with a suitable solvent system (B) comprising (B1) dioxolane and optionally (B2) an alcohol solvent, in any order and stirring, agitating, and/or homogenizing at a temperature between 2° and 100° C. for a suitable amount of time to form a homogeneous solution.

In one example, the inkjet ink may be made by first combining the terpene resin (A1) with the dioxolane (B1), and any optional resins (e.g., terpene phenol resin (A2)), optional alcohol solvents (B2), optional surfactants (D), or other optional additive(s) (E) in a vessel, followed by stirring for preferably at least 10 minutes, preferably at least 15 minutes, preferably at least 20 minutes, preferably at least 25 minutes, preferably at least 30 minutes, preferably at least 35 minutes, preferably at least 40 minutes, preferably at least 45 minutes. The colorant (C) may then be added as the final component with continued mixing, and the solution may then be mixed for preferably at least 10 minutes, preferably at least 15 minutes, preferably at least 20 minutes, preferably at least 25 minutes, preferably at least 30 minutes, preferably at least 35 minutes, preferably at least 40 minutes, preferably at least 45 minutes to afford the inkjet ink. The resulting inkjet ink may then be placed into a printing cartridge, such as e.g., a FUNAI TIJ cartridge made by Funai Co., or other printhead suitable for ketone-based ink.

### Properties

The inkjet inks disclosed herein possess extended decap times, for example as measured by printing a narrow line picture (e.g., barcode) (1 mm*1 cm, narrow lines, Monochrome bitmap), exposing the inkjet ink to air (decapping the ink cartridge) for a particular time (e.g., 30 seconds, 1 minute, 10 minutes, 60 minutes, etc.), reprinting the same narrow line image, and comparing the reprinted image after decapping to the original image to determine if loss of lines/loss of line clarity occurs in the narrow line image. If no loss of lines/loss of line clarity occurs at the tested time interval, then the inkjet inks are given a “Good” decap rating for that time interval. If 1-2 lines are lost/lost clarity at the tested time interval, but not enough to significantly affect the clarity or readability of the narrow line image, then the inkjet inks are given an “Acceptable” decap rating for that time interval. If more than 2 lines are lost/lost clarity at the tested time interval, then the inkjet ink is classified as “Not Good” at that time interval. Suitable inkjet inks are those which achieve an “Acceptable” or “Good” decap classification when decapped (i.e., exposed to air) for 30 seconds, preferably 1 minute, more preferably 10 minutes, even more preferably 30 minutes, yet even more preferably 60 minutes.

The inkjet inks disclosed herein are also characterized by a long running stability (also known as ink longevity or print longevity). To test the inkjet inks for running stability, a narrow line image (e.g., barcode) (1 mm*1 cm, narrow lines, Monochrome bitmap) may be printed uninterrupted for a consecutive number of pages (e.g., printed on 3,000 pages in a continuous printing operation), and the print quality may be assessed throughout the printing operation by visually inspecting certain pages (e.g., 1,000^{th}, 2,000^{th}, and 3,000^{th} page) for missing nozzles. If no loss of lines/loss of line clarity occur in the page being inspected, then the inkjet ink is given a “G” (Good) running stability rating for that page. If 1-2 lines are lost/lost clarity in the page being inspected, but not enough to significantly affect the clarity or readability of the narrow line image, then the inkjet ink is given an “A” (Acceptable) running stability rating for that page. If more than 2 lines are lost/lost clarity in the page being inspected, then the inkjet ink is given an “NG” (Not Good) running stability rating for that print. Inkjet inks which maintain a “G” or “A” rating, preferably a “G” rating, when printed for at least 100 pages, preferably at least 500 pages, preferably at least 1,000 pages, preferably at least 1,500 pages, preferably at least 2,000 pages, preferably at least 2,500 pages, preferably at least 3,000 pages, preferably at least 3,500 pages, preferably at least 4,000 pages, preferably at least 4,500 pages, preferably at least 5,000 pages, are considered desirable in terms of running stability (ability to remain dispersed/suspended without settling/sedimentation and improper jetting).

The inkjet inks disclosed herein are also characterized by superior adhesion to a variety of substrates. Adhesion is typically tested using a “peeled tape test” in which an adhesive tape, typically 3M Scotch® tape, particularly Scotch® Light Duty Packaging Tape 600, is applied to a dried printed ink, then removed. Good ink adhesion is characterized by little to no ink being removed from the substrate, i.e. little to no ink detectable on the adhesive tape, and/or no detectable change to the printed ink. An “Acceptable” rating is characterized by a significant amount of ink being removed from the substrate, i.e. ink visible on the adhesive tape, and/or a noticeable change to the printed ink, e.g. reticulation or fading.

A “Not Good” rating is characterized by a large amount of ink being removed from the substrate, i.e. large amounts of ink visible on the adhesive tape (a reproduction of the print may be visible on the adhesive tape), and/or the print is significantly degraded in quality, e.g. reticulation or fading).

The inkjet inks disclosed herein may also be characterized by long throw distance. The throw distance of an inkjet ink may be measured by printing a test pattern with increasing distances between the printhead and the substrate and assessing the quality of the image at each distance. This may include printing an image such as an alphanumeric sequence at various throw distances (e.g., 2 mm, 4 mm, 6 mm, 8 mm, and 10 mm) and visually assessing the quality of printed image in terms of image clarity, edge definition, and accuracy of drop placement. If the printed image is clearly readable, with well-defined edges and accurate drop placement, then the inkjet inks are given a “Good” throw distance rating for that tested throw distance. If the printed image is readable, but has some haziness, slight loss of edge definition, and/or slight loss of drop placement accuracy, then the inkjet inks are given an “Acceptable” throw distance rating for that tested throw distance. If the printed image is not readable, because the images lack clarity, have poor edge definition and/or inaccurate drop placement, then the inkjet inks are given a “Not Good” throw distance rating for that tested throw distance. Preferred inkjet inks are those which maintain a “Good” or “Acceptable” throw distance evaluation for throw distances of at least 1 mm, preferably at least 2 mm, preferably at least 3 mm, preferably at least 4 mm, preferably at least 5 mm, preferably at least 6 mm, preferably at least 7 mm, more preferably at least 8 mm, even more preferably at least 9 mm, yet even more preferably at least 10 mm.

Another advantage of the disclosed inkjet inks is that they can be readily tuned and adjusted for optical density to meet consumer needs, needs for a particular application, etc. Optical density of the inks may be measured by printing a solid block image (e.g., 1 cm*10 cm) and taking optical density readings with a spectrophotometer (e.g., X-rite eXact, Density/TVI mode, sold by X-rite). As optical density is the measure of reflected or absorbed light being pulled into the printed surface, optical density values are dimensionless. Inkjet inks that produce images with optical density readouts of under 1.90 are considered to provide low optical density images, whereas those inkjet inks that provide optical density readouts of 1.90 or higher are deemed to provide high optical density images. Typical inkjet inks of the present disclosure provide images with an optical density of at least 1.90, preferably at least 2.00, preferably at least 2.10, preferably at least 2.20, preferably at least 2.30, preferably at least 2.40, preferably at least 2.50, though optical density values above or below these ranges can also be produced, as desired.

To test the inkjet inks for legibility (opacity) on a dark colored substrate, the inkjet inks may be used to print a solid block image (e.g., 1 cm*10 cm) onto a black substrate such as the black portion of the Form 2C Opacity Chart, available from Leneta Company, Inc. The color difference (denoted by ΔE*_{ab}) between the silver solid block image and the black portion of the Form 2C Opacity Chart may then be determined by measuring the CIELAB color space (a* and b* and L* values) of each using an appropriate colorimeter (e.g., eXact colorimeter by X-Rite), and calculating the color difference according to the formula:

$$Δ {E}_{a b}^{*} = \sqrt{{( Δ {L}^{*} )}^{2} + {( Δ {a}^{*} )}^{2} + {( Δ {b}^{*} )}^{2}}$$

Inkjet inks which provide a ΔE*_{ab} value of 10 or higher when printed on the black portion of the Form 2C Opacity Chart are considered herein to be desirable in terms of their legibility (opacity), whereas inkjet inks which provide a ΔE*_{ab} value of less than 10 are considered to provide inadequate opacity (illegible).

### Printed Article

The inkjet inks can be printed on various substrates including three dimensional parts as well as flat sheets or webs that are supplied in roll form, for the manufacture of a wide variety of printed articles. While flat substrates are suitable substrates for forming printed articles, a particular advantage of the present disclosure is that the disclosed inkjet inks-having long throw distance capabilities-enable printed images to be formed on complex three dimensional substrates, such as those which are radial, curved, serrated, corrugated, fluted, lipped, and/or those which have a structured surface (e.g., grained surface), all of which are notoriously difficult substrates owing to the long distance that the ink must travel to reach all parts of the complex surface. The printed articles may be suitable in the graphic arts, textiles, packaging (e.g., food packaging, pharmaceutical packaging, etc.), lottery, direct mail, business forms and publishing industries, examples of which include a tag or label, a lottery ticket, a publication, packaging (e.g., food packaging, pharmaceutical packaging, blister packaging, other various flexible packing, etc.), a folding carton, a rigid container (e.g., a plastic cup or tub, glass containers, metal cans, bottles such as PET bottles, jars, and tubes), envelopes, corrugate, a point-of-sale display, and the like. Particularly preferred printed articles are those having a dried form of the inkjet ink disposed on a complex three dimensional part of the printed article, for example, where the printed image is located on a fluted or corrugated portion of a plastic container, or on the concave dome-shaped bottom of a metal can.

The inkjet inks may be printed on porous (or penetrable) substrates, examples of which include, but are not limited to, non-coated paper, wood, membranes, corrugate (corrugated cardboard/fiberboard), and fabrics (including, for example, but not limited to, woven fabric, non-woven fabric, and foil-laminated fabric).

The inkjet inks may also be printed on non-porous (or non-penetrable substrates), for example, various plastics, glass, metals (e.g., steel, aluminum, etc.), and/or non-penetration papers (e.g., coated papers such as varnish coated papers), including, but not limited to, molded plastic or metal parts as well a flat sheets or rolls of plastic or metallic films. Examples include those substrates containing polyesters such as polyethylene terephthalate (PET), biaxially oriented polystyrene (OPS), polyolefins such as polyethylene (PE), polypropylene (PP), oriented polypropylene (OPP), and biaxially oriented polypropylene (BOPP), polylactic acid (PLA), nylon and oriented nylon, polyvinyl chloride (PVC), cellulose triacetate (TAC), polycarbonate, acrylonitrile butadiene styrene (ABS), polyacetal, polyvinyl alcohol (PVA), coated papers such as varnish coated papers, and metals such as steel and aluminum, and the like.

### Method of Forming a Printed Image

The present disclosure provides a method of forming a printed image on a substrate, comprising applying the inkjet ink of one or more of its embodiments onto the substrate with a drop on demand printhead and drying the inkjet ink.

With inkjet printing, a desired printed image is formed when a precise pattern of dots is ejected from a drop-generating device, known as a printhead, onto a print medium. The printhead has an array of precisely formed nozzles located on a nozzle plate and attached to an inkjet printhead substrate. The inkjet printhead substrate incorporates an array of firing chambers that receive inkjet ink through fluid communication with one or more ink reservoirs.

Any drop on demand printhead known to those of ordinary skill in the art of inkjet printing can be used as printing units in the present method, including thermal printheads, electrostatic printheads, piezoelectric printheads and acoustic printheads, preferably a thermal printhead (having a thermal transducer) is used.

Each firing chamber has a resistor element (i.e. a thermal transducer), known as a firing resistor, located opposite the nozzle so that the inkjet ink collects between the firing resistor and the nozzle. Each resistor element is typically a pad of a resistive material and measures for example about 35 μm×35 μm. The printhead is held and protected by an outer packaging referred to as a print cartridge or an inkjet pen. Upon energizing of a particular resistor element, a droplet of inkjet ink is expelled through the nozzle toward the print medium. The firing of ink droplets is typically under the control of a microprocessor, the signals of which are conveyed by electrical traces to the resistor elements, forming alphanumeric and other image patterns on the print medium. Since the nozzles are small, typically 10 μm to 40 μm in diameter, inks that minimize clogging are desired. In particular, since thermal inkjet (TIJ) is an open atmosphere print head design (the nozzle orifices are open to atmosphere and there is no valve seal at the orifice to allow ink pressurization), TIJ printing has historically suffered from poor performance during intermittent printing, where decap time (print idle time) causes premature drying of ink in and around the nozzles.

The present disclosure provides a method of forming a printed image by applying the inkjet ink, in one or more of its embodiments, onto a surface of a substrate by a thermal inkjet printhead and drying the inkjet ink. Use of the inkjet inks described herein overcomes the problem of short decap time (rate of solvent loss is too fast) commonly associated with thermal inkjet processes.

Typical parameters, such as, for example, printing resolution, printing speed, printhead pulse warming temperature, driving voltage and pulse length, can be adjusted according to the specifications of the printhead. Printheads which are generally suitable for usage in the methods herein have a droplet size in the range of 2 to 80 μL and a droplet frequency in the range of 10 to 100 kHz, and high quality prints may be obtained for example by setting the driving voltage to 8.0 to 9.5 Volts, the print speed up to 300 feet/minute, the pulse warming temperature to 25 to 45° C., and the pulse length to 0.7-2.5 microseconds, although values above or below these described may also be used and still obtain satisfactory prints. One non-limiting printhead example suitable for use in the disclosed methods is FUNAI TIJ cartridge made by Funai Co.

After application, the inkjet ink is dried. In some embodiments, external heat may be applied to dry the applied inkjet inks, for example, through the use of a heater. However, it is preferred that no external heat is applied to facilitate drying or to increase drying speeds. Therefore, in preferred embodiments, drying is achieved by allowing the applied inkjet ink to dry under ambient conditions (in air, at about 23° C.) for 30 seconds or less, preferably 25 seconds or less, more preferably 20 seconds or less, even more preferably 15 seconds or less, yet even more preferably 10 seconds or less, without the use of an external heat source such as a heater. Furthermore, the methods of the present disclosure do not require energy curing (e.g., UV or electron beam curing). Once the applied ink is deemed dry, further coatings of inkjet ink may be applied, or any processing steps known to those of ordinary skill in the art may be performed as desired.

It should also be recognized that substrate surface treatments such as corona treatment, atmospheric plasma treatment, and flame treatment may optionally be employed in the methods herein prior to application of the inkjet inks to improve printed article characteristics, for example ink adhesion. The parameters of such substrate surface treatments may be varied greatly depending on the substrate material to be printed, the specific inkjet ink utilized, the printing method applied, and the desired properties and applications of the printed article.

The examples below are intended to further illustrate the inkjet inks and are not intended to limit the scope of the claims.

### Examples

### Materials

PICCOLYTE A25 is a terpene resin made from α-pinene (ring-and-ball SP=22-28° C.), available from Pinova. DERTOPHENE T160 is a terpene phenol resin (OHV=60 mgKOH/g; SP=160° C.; Mw=about 1,000 g/mol), available from DRT/Pinova. BYK-3550 is a silicone acrylate copolymer surfactant, available from BYK Additives & Instruments. OIL BLACK 860 (also known as Solvent Black 3 or SB3) is an organic dye, available from Orient Chemical Industries. Valifast Black 1821 (also known as Solvent Black 7 or SB7) is a nigrosine metal complex dye, available from Orient Chemical Industries. Valifast Black 3830 (also known as Solvent Black 27 or SB27) is a metal complex azo dye, available from Orient Chemical Industries.

### Inkjet Ink Evaluation Methods

### Printing Sample Preparation

The inkjet ink examples were evaluated through a FUNAI TIJ cartridge made by Funai Co. Thermal printing technology related to FUNAI was used to evaluate the inks (Software and hardware made by Weber Marking Systems, Transport table made by Kirk Rudy).

### Decap Time Evaluation

For evaluating decap times, the printing conditions utilized were as follows:
Printing substrate; normal (non-coated) paper
Printing resolution; 300 dpi*300 dpi (vertical*horizontal)
Pre Fire 450 nsec
Dead Time 1200 nsec
Main Fire 1500 nsec
Voltage 9.5 V
Pulse warming ON at 35° C.
Printing image; 100% duty (1 mm*1 cm, Monochrome bitmap, narrow line image) (see e.g., FIG. 2)

The narrow line image was printed to confirm that there were no missing or unclear lines included in the printed image (signifying plugged or missing nozzles). After confirming, the printhead was left decapped for a specific time (30 seconds, 1 min, 10 min, or 60 min), then reprinted using the same narrow line image. The reprinted narrow line image (after the specific time lapse) was checked to determine whether loss of lines/loss of line clarity occurred. If no loss of lines/loss of line clarity occurred, then the inkjet inks were given a “Good” decap rating for that time interval. If 1-2 lines were lost/lost clarity at the tested time interval, but not enough to significantly affect the clarity or readability of the narrow line image at the tested time interval, then the inkjet inks were given an “Acceptable” decap rating for that time interval. If more than 2 lines were lost/lost clarity at the tested time interval, then the inkjet inks were classified as “Not Good” at that time interval. Suitable/desirable inkjet inks are those which achieve a, “Acceptable” or “Good” decap classification when decapped (i.e., exposed to air) for each of the tested time intervals.

### Print Longevity Evaluation

For evaluating the running stability of the inkjet inks during printing operations (the ability to remain dispersed/suspended without settling/sedimentation), the printing conditions utilized were as follows:
Printing substrate; non-coated paper (plain paper)
Printing resolution; 300 dpi*300 dpi (vertical*horizontal)
Printing image; 100% duty (1 mm*1 cm, Monochrome bitmap, narrow line image).

The narrow line image was printed uninterrupted for 500 consecutive prints, and the print quality of the 500^{th} print was determined through visual inspection methods by checking for any missing nozzles. If no loss of lines/loss of line clarity occurred, then the inkjet ink was given a “G” (Good) running stability rating. If 1-2 lines were lost/lost clarity, but not enough to significantly affect the clarity or readability of the narrow line image, then the inkjet ink was given an “A” (Acceptable) running stability rating. If more than 2 lines were lost/lost clarity, then the inkjet ink was given an “NG” (Not Good) running stability rating. Suitable/desirable inkjet inks are those which maintain a “G” or an “A” running stability rating for the 500^{th} print.

### Adhesion Evaluation

The ink was printed on LDPE films. 1 minute after printing, Scotch® Light Duty Packaging Tape 600 was applied to the ink with light pressure, then immediately peeled off. The performance of the ink was ranked according to the description provided in Table 1, below.

TABLE 1
Ink evaluation metrics

| | | Image quality | Adhesion |
|---|---|---|---|
| Rating | Description | outcome | (Tape Test) |
| Good | Clear images; | Clearly | Little to no ink on tape; no |
| | well-defined edges | readable | change to print |
| Acceptable | Images were mostly clear but | Readable | Significant ink on tape; |
| | with some haziness; slight | | noticeable change to print |
| | loss of edge definition | | |
| Not Good | Images lacked clarity; poor | Not readable | Large amount of ink on |
| | edge definition | | tape; print significantly |
| | | | degraded in quality |

### Inkjet Ink Examples

Example inkjet inks are given in Table 2. The amount of each component is expressed in terms of weight percentage relative to a total weight (100%) of the inkjet ink.

* denotes the example is a comparative example.

### Preparation Methods

To prepare the example inks, the resin(s) and any surfactant were first combined with the stated combination of dioxolane, and 1-propanol, and mixed by mechanical stirrer for at least 30 minutes. The dye was then added into the mixture and mixed for at least 30 minutes to obtain the inkjet inks. The inkjet ink examples were then evaluated through a FUNAI TIJ cartridge made by Funai Co.

TABLE 2
Inkjet Ink Examples 1-12

| Component | | Ex 1 | Ex 2* | Ex 3 | Ex 4 | Ex 5* | Ex 6 | Ex 7* | Ex 8 | Ex 9 | Ex 10 | Ex 11* | Ex 12* |
|---|---|---|---|---|---|---|---|---|---|---|---|---|---|
| 1,3-Dioxolane | B1 | 75.9 | 75.9 | 85.9 | 90.9 | 75.9 | 76.4 | 76.7 | 60.9 | 76.3 | 74.2 | — | 76.4 |
| 1-propanol | B2 | 15.0 | 15.0 | 5.0 | — | 15.0 | 15.0 | 15.0 | 30.0 | 15.0 | 15.0 | 15.0 | 15.0 |
| Ethanol | B3 | — | — | — | — | — | — | — | — | — | — | 75.9 | — |
| PICCOLYTE A-25 | A1 | 0.8 | 0.8 | 0.8 | 0.8 | 0.8 | 0.8 | — | 0.8 | 0.4 | 2.5 | 0.8 | — |
| DERTOPHENE T160 | A2 | 0.5 | 0.5 | 0.5 | 0.5 | 0.5 | — | 0.5 | 0.5 | 0.5 | 0.5 | 0.5 | — |
| JONCRYL-680 | A3 | — | — | — | — | — | — | — | — | — | — | — | 0.8 |
| BYK-3550 | C | 0.8 | 0.8 | 0.8 | 0.8 | 0.8 | 0.8 | 0.8 | 0.8 | 0.8 | 0.8 | 0.8 | 0.8 |
| VALIFAST BLACK | D | 7.0 | — | 7.0 | 7.0 | — | 7.0 | 7.0 | 7.0 | 7.0 | 7.0 | 7.0 | 7.0 |
| 3830 (SB27) | | | | | | | | | | | | | |
| OIL BLACK 860 | D | — | 7.0 | — | — | — | — | — | — | — | — | — | — |
| (SB3) | | | | | | | | | | | | | |
| VALIFAST BLACK | D | — | — | — | — | 7.0 | — | — | — | — | — | — | — |
| 1821 (SB7) | | | | | | | | | | | | | |
| Total | | 100.0 | 100.0 | 100.0 | 100.0 | 100.0 | 100.0 | 100.0 | 100.0 | 100.0 | 100.0 | 100.0 | 100.0 |

*denotes the example is a comparative example

### Inkjet Ink Performance

From Table 3 it can be seen that the combination of Valifast Black 3830 (SB27), dioxolane, and terpene resin provided remarkable effects in terms of decap times, print longevity, and adhesion (Examples 1, 3, 4, 6, and 9). Conversely, inkjet inks formulated without dioxolane (Example 11) and without pinene-based terpene resins (Examples 7 and 12) underperformed in each test, providing results categorized as “Not Good” for all decap times. Each of these examples was also characterized as “Not Good” for print longevity of 3000 and 5000 pages for Example 7 and for all print longevity tests for Examples 11 and 12. Because of these unsatisfactory results, the adhesion test was not performed on Examples 11 and 12.

It was also discovered that not all colorants were compatible with the dioxolane/terpene system. Inkjet inks formulated without Valifast Black 3830 (Examples 2 and 5) were found to be unsuitable. Using Oil Black 860, an organic dye, showed “Good” results for all decap times, but poor print longevity and adhesion on LDPE (Example 2). Using Valifast Black 1821, a nigrosine metal complex dye, showed good adhesion on all tested substrates, but poor results for all decap times and print longevity (Example 5).

In terms of the quantity of dioxolane, loadings in the range of 60.9-90.9 wt. % were found to provide acceptable or better decap behavior for all decap times, acceptable or better print longevity up to 5000 pages, and acceptable or better adhesion on all substrates (Examples 1, 3, 4, 6, 8, 9, and 10). Completely removing dioxolane resulted in unsatisfactory performance for all decap times and print longevity tests (Example 11). While including including 90.9 wt. % dioxolane and no alcohol solvent produced mostly acceptable results (Example 4), better results were obtained with an optimal amount of 15 wt. % 1-propanol (Examples 1 and 3).

TABLE 3
Evaluation of Inkjet Ink Examples 1-12

| | Ex 1 | Ex 2* | Ex 3 | Ex 4 | Ex 5* | Ex 6 | Ex 7* | Ex 8 | Ex 9 | Ex 10 | Ex 11* | Ex 12* |
|---|---|---|---|---|---|---|---|---|---|---|---|---|
| Decap Time/ | G | G | A | A | NG | G | NG | A | A | A | NG | NG |
| 30 sec | | | | | | | | | | | | |
| Decap Time/ | G | G | G | A | NG | G | NG | A | A | A | NG | NG |
| 1 min | | | | | | | | | | | | |
| Decap Time/ | G | G | G | G | NG | G | NG | A | G | A | NG | NG |
| 10 min | | | | | | | | | | | | |
| Decap Time/ | G | G | G | G | NG | G | NG | G | G | A | NG | NG |
| 60 min | | | | | | | | | | | | |
| Print Longevity | G | G | G | G | NG | G | G | G | G | G | NG | NG |
| 1000 pg | | | | | | | | | | | | |
| Print Longevity | G | NG | G | G | NG | G | NG | A | G | G | NG | NG |
| 3000 pg | | | | | | | | | | | | |
| Print Longevity | G | NG | G | G | NG | G | NG | A | G | A | NG | NG |
| 5000 pg | | | | | | | | | | | | |
| Adhesion on | G | A | G | G | G | G | A | A | G | G | — | — |
| Lenta Card | | | | | | | | | | | | |
| Adhesion on | G | NG | G | G | G | A | A | A | G | G | — | — |
| LDPE | | | | | | | | | | | | |
| Adhesion on | G | G | G | G | G | A | G | A | G | G | — | — |
| BOPP | | | | | | | | | | | | |

G: Good;
A: Acceptable;
NG: Not Good;
*denotes the example is a comparative example

Where a numerical limit or range is stated herein, the endpoints are included. Also, all values and subranges within a numerical limit or range are specifically included as if explicitly written out.

As used herein the words “a” and “an” and the like carry the meaning of “one or more.”

The present disclosure also contemplates other embodiments “comprising”, “consisting of” and “consisting essentially of”, the embodiments or elements presented herein, whether explicitly set forth or not.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An inkjet ink, comprising:
a terpene resin;
a solvent system comprising dioxolane; and
a colorant comprising a metal complex azo dye.

2. The inkjet ink of claim 1, wherein the terpene resin is present in an amount of 0.1 to 10 wt. %, based on a total weight of the inkjet ink.

3. The inkjet ink of claim 1, wherein the terpene resin is a homopolymer made from α-pinene.

4. The inkjet ink of claim 1, wherein the dioxolane is present in an amount of 2 to 98 wt. %, based on a total weight of the inkjet ink.

5. The inkjet ink of claim 1, wherein the solvent system further comprises an alcohol solvent.

6. The inkjet ink of claim 5, wherein the alcohol solvent is present in an amount of 0.5 to 60 wt. %, based on a total weight of the inkjet ink.

7. The inkjet ink of claim 5, wherein a weight ratio of dioxolane to the alcohol solvent is 0.25:1 to 30:1.

8. The inkjet ink of claim 1, wherein a weight ratio of dioxolane to the terpene resin is 20:1 to 250:1.

9. The inkjet ink of claim 1, wherein the solvent system is substantially free of methyl ethyl ketone.

10. The inkjet ink of claim 9, wherein the solvent system is devoid of methyl ethyl ketone.

11. The inkjet ink of claim 1, wherein the metal complex azo dye is a metal complex comprising:
a metal center; and
(E)-1-((2-methoxy-5-nitrophenyl)diazenyl)naphthalen-2-ol or a deprotonated form, demethylated form, deprotonated and demethylated form, tautomer, or stereoisomer thereof.

12. The inkjet ink of claim 11, wherein the metal center is a chromium ion.

13. The inkjet ink of claim 1, wherein the colorant is present in an amount of 0.5 to 20 wt. %, based on a total weight of the inkjet ink.

14. The inkjet ink of claim 1, further comprising a terpene phenol resin.

15. The inkjet ink of claim 14, wherein the terpene phenol resin is present in an amount of 0.01 to 10 wt. %, based on a total weight of the inkjet ink.

16. The inkjet ink of claim 1, further comprising a surfactant.

17. The inkjet ink of claim 16, wherein the surfactant is present in an amount of 0.01 to 5 wt. %, based on a total weight of the inkjet ink.

18. The inkjet ink of claim 16, wherein the surfactant is a silicone acrylate copolymer.

19. A printed article, comprising:
a substrate and a dried form of the inkjet ink of claim 1 disposed on the substrate.

20. A method of forming a printed image on a substrate, comprising:
applying the inkjet ink of claim 1 onto the substrate with a thermal inkjet printhead; and
drying the inkjet ink.
